(19) United States
(12) Patent Application Publication
(10) Pub. No.: US 2008/0299481 A1
(43) Pub. Date: Dec. 4, 2008

(54) Liquid Developer and Image Forming Apparatus

(75) Inventor: Koji Akioka, North Adelaide (AU)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/056,092

(22) Filed: Mar. 26, 2008

(30) Foreign Application Priority Data
May 31, 2007 (JP) 2007-146281

(51) Int. Cl. G03G 9/13; G03G 15/00

(52) U.S. Cl. 430/113; 399/308

(57) ABSTRACT

A liquid developer includes: toner particles containing mainly a resin material, and a nonvolatile insulating liquid, the toner particles containing a liquid having a formulation that is different from the insulating liquid, and the liquid contained in the toner particles having an aniline point that is lower than that of the insulating liquid.

### BACKGROUND

1. Technical Field

The present invention relates to a liquid developer and an image forming apparatus.

2. Related Art

A developer for developing an electrostatic latent image formed on a latent image carrying member includes a dry toner used in a dry state constituted by a material containing a colorant, such as a pigment, and a binder resin, and a liquid developer (liquid toner) constituted by a toner dispersed in an electrically insulating carrier liquid (insulating liquid).

A method using a dry toner is advantageous owing to the use of a toner in a solid state, but has a concern of adverse influence of powder to a human body and has a problem in contamination due to scattering of the toner. A dry toner is liable to suffer aggregation, and the size of the toner particles is difficult to reduce, whereby a toner image having high resolution is difficult to form. In the case where the size of the toner particles is relatively small, the aforementioned problems due to the powder form of the toner conspicuously arise.

In a method using a liquid developer, the toner particles in the liquid developer are effectively prevented from being aggregated, whereby fine toner particles can be used, and a binder resin having a low softening point (low softening temperature) can be used. Accordingly, the method using a liquid developer is advantageous in reproducibility of a thin line image, favorable in gradation reproducibility, and excellent in color reproducibility, and is suitable for a high-speed image forming method.

A liquid developer is demanded to have dispersion stability (storage stability) in that, upon storing, the state where toner particles are dispersed in a liquid is maintained for a prolonged period of time to prevent the toner particles from suffering aggregation and deformation. A liquid developer in related art has had the following problems. An insulating liquid having been used in a liquid developer is generally formed mainly of a petroleum hydrocarbon. In the liquid developer, the insulating liquid is attached to the surface of the toner particles upon fixing. In the liquid developer, the fixing strength has been lowered due to the presence of the insulating liquid attached to the surface of the toner particles, so as to fail to provide sufficient fixing characteristics.

Such an attempt has been made for solving the problems in that a naturally derived oil, such as vegetable oil as an insulating liquid, is used to improve fixing strength through oxidation polymerization reaction of the oil upon fixing (as described, for example, in JP-A-2006-251252). However, the fixing strength is improved with the liquid developer using a naturally derived oil, but sufficient fixing strength is still not obtained. The liquid developer further has a problem of offset frequently occurring upon fixing at a low temperature associated with energy saving in recent years.

### SUMMARY

An advantage of some aspects of the invention is to provide such a liquid developer that is environmentally benign, is excellent in storage stability and low temperature fixing property, and an image forming apparatus using the liquid developer.

According to an aspect of the invention, a liquid developer is provided that contains toner particles containing mainly a resin material, and a nonvolatile insulating liquid. The toner particles contain a liquid having a formulation that is different from the insulating liquid. The liquid contained in the toner particles has an aniline point that is lower than that of the insulating liquid.

It is preferred in the liquid developer according to the aspect of the invention that the liquid contained in the toner particles has an aniline point of 30° C. or less, and the insulating liquid has an aniline point of from 5 to 100° C.

It is preferred in the liquid developer according to the aspect of the invention that the liquid developer satisfies the relationship, 10≦AP(b)−AP(a)≦100, wherein AP(a) (° C.) represents the aniline point of the liquid contained in the toner particles, and AP(b) (° C.) represents the aniline point of the insulating liquid.

It is preferred in the liquid developer according to the aspect of the invention that the resin material has a melting point of from 80 to 140° C. measured according to JIS K7121 1987.

It is preferred in the liquid developer according to the aspect of the invention that the resin material contains an ethylene copolymer and has a Vicat softening temperature of from 40 to 100° C. measured according to JIS K7026 1999.

It is preferred in the liquid developer according to the aspect of the invention that the liquid developer satisfies the relationship, Tm-Tv≦50, wherein Tv (° C.) represents the Vicat softening point of the resin material measured according to JIS K7026 1999, and Tm (° C.) represents the melting point of the resin material measured according to JIS K7121 1987.

It is preferred in the liquid developer according to the aspect of the invention that the resin material contains a polyester resin and has a glass transition temperature of from 40 to 75° C. measured according to JIS K7121.

It is preferred in the liquid developer according to the aspect of the invention that the liquid developer satisfies the relationship, Tm-Tg≦80, wherein Tg (° C.) represents the glass transition temperature of the resin material measured according to JIS K7121, and Tm (° C.) represents the melting point of the resin material measured according to JIS K7121 1987.

According to another aspect of the invention, an image forming apparatus is provided that contains: plural developing units that provide plural monochrome images having different colors by using plural liquid developer having the different colors; an intermediate transferring unit that forms an intermediate transferred image containing the plural monochrome images formed in the developing units, the plural monochrome images being sequentially transferred and overlapped to form the intermediate transferred image; a secondary transferring unit that transfers the intermediate transferred image to a recording medium to form an unfixed color image on the recording medium; and a fixing unit that fixes the unfixed color image to the recording medium. The liquid developers each contain toner particles containing mainly a resin material, and an insulating liquid. The toner particles contain a liquid having a formulation that is different from the insulating liquid. The liquid contained in the toner particles has an aniline point that is lower than that of the insulating liquid.

According to the aspects of the invention, a liquid developer that is environmentally benign, is excellent in storage stability and low temperature fixing property and is capable of fixing toner particles firmly to a recording medium, and an image forming apparatus using the above-mentioned liquid developer are provided.

### BRIEF DESCRIPTION OF THE DRAWINGS

The invention will be described with reference to the accompanying drawings, wherein like numbers reference like elements.

FIG. 1 is a cross sectional view showing an example of an image forming apparatus, to which a liquid developer according to an embodiment of the invention is applied.

FIG. 2 is an enlarged view showing a part of the image forming apparatus shown in FIG. 1.

FIG. 3 is a schematic illustration showing an example of a state of toner particles in a liquid developer layer on a developing roller.

FIG. 4 is a cross sectional view showing an example of a fixing device applied to the image forming apparatus shown in FIG. 1.

### DESCRIPTION OF EXEMPLARY EMBODIMENTS

An embodiment of the invention will be described in detail with reference to exemplary embodiments.

### Liquid Developer

The liquid developer according to an embodiment of the invention contains an insulating liquid having dispersed therein toner particles.

### Toner Particles

The toner particles will be described.

### Constitutional Components of Toner Particles (Toner Materials)

The toner particles constituting the liquid developer of the embodiment of the invention contains at least a liquid (liquid component) having a formulation that is different from the insulating liquid, and a resin material. The liquid component in the toner particles has an aniline point that is lower than the aniline of the insulating liquid constituting the liquid developer.

An aniline point is generally used as an index of dissolution power of an organic solvent to a resin or the like. In general, an organic solvent having a lower aniline point has higher dissolving power to a resin or the like. The toner particles of the liquid developer according to the embodiment of the invention contain the liquid component, and in the case where the liquid component has a relatively low aniline point, the liquid developer has a function of plasticizing the resin component contained in the toner particles to lower the melting point thereof (i.e., plasticizing effect). Accordingly, in the case where the liquid component contained in the toner particles has a relatively low aniline point, the liquid developer easily permeates the molecular chains of the resin material constituting the toner particles when the toner particles are heated upon fixing to increase the distances among the molecular chains, whereby the plasticizing effect is significantly exhibited, and the toner particles are easily melted and fixed to the recording medium. Consequently, the toner particles are fixed firmly to the recording medium, and the fixing strength of the toner image obtained is improved. For example, in the case where paper is used as the recording medium, the toner particles are liable to penetrate into fibers of the paper. A part of the toner particles (i.e., the resin material constituting the toner particles) melted by heating upon fixing penetrates into the interior of the recording medium, and then by hardening the toner particles by standing to cool in this state, anchoring effect is exhibited to improve the fixing characteristics between the paper and the toner particles. Therefore, a liquid developer containing the toner particles is excellent in high-speed and low temperature fixing property and is excellent in fixing strength of a toner image formed.

An aniline point of a liquid can be obtained as the minimum temperature where the same amounts of aniline and the liquid are present as a uniform solution. Specifically, the aniline point is obtained in the following manner. A mixture of aniline and the liquid is heated under stirring to provide a completely mixed transparent state. The temperature of the mixture is then decreased, and the temperature, at which the mixture starts to be turbid, is designated as the aniline point. The aniline point referred herein is a value that is measured and obtained according to JIS K2256.

The resin material plasticized with the liquid component has a lower melting point than the same resin material that is not plasticized with the liquid component. Accordingly, the plasticization of the resin component in the toner particles with the liquid component can be confirmed by comparing the melting point of the resin material constituting the toner particles. In the case where the melting point of the toner particles is lower than that of the resin material constituting the toner particles, it can be understood that the resin material in the toner particles is plasticized with the liquid component.

Furthermore, the liquid developer of the embodiment of the invention uses an insulating liquid having an aniline point that is higher than that of the liquid contained in the toner particles, as described later. By using an insulating liquid having a relatively high aniline point, the surface part of the toner particles can be certainly prevented from being plasticized excessively upon storing, and thus the toner particles can be certainly prevented from suffering deformation and aggregation. Consequently, the liquid developer is improved in storage stability.

In the case where the toner particles do not contain the liquid component as described above, on the other hand, the aforementioned advantages cannot be obtained. Specifically, toner particles that do not contain the above-described liquid component cannot be favorably melted with heat upon fixing at a low temperature, and thus cannot be firmly fixed to a recording medium. Accordingly, a fixed toner image is inferior in fixing strength. Furthermore, the fixed toner image is liable to suffer low temperature offset. It may be considered that a large amount of a liquid having a relatively low aniline point is added to the insulating liquid to accelerate the plasticizing effect of the above-described resin material upon fixing, so as to obtain toner particles excellent in low temperature fixing property. In this case, however, the resin material inside the toner particles (particularly, in the vicinity of the center of the toner particles) suffers excessive plasticization upon storing, which may induce aggregation of the toner particles. Thus, the liquid developer is deteriorated in storage stability. It may also be considered that the toner particles are constituted with a resin material having a low melting point to improve the liquid developer in low temperature fixing property. In this case, however, the toner particles are liable to suffer aggregation and unintended deformation of the toner particles upon storing, whereby the liquid developer is deteriorated in storage stability.

The components constituting the toner particles will be described in detail below.

### 1. Liquid Component

The toner particles contain a liquid component having a relatively low aniline point, as described above.

The aniline point of the liquid component may be lower than the aniline point of the insulating liquid constituting the liquid developer, and specifically, is preferably 30° C. or less, and more preferably 0° C. or less. According to the constitution, the plasticizing effect upon fixing can be significantly obtained, whereby the liquid developer can be particularly improved in low temperature fixing property and fixing characteristics, and the toner particles can be certainly prevented from suffering deformation and aggregation.

The liquid component contained in the toner particles contains, as a major component, a first liquid produced in the method described later.

The liquid is not particularly limited as far as it has an aniline point that is lower than that of the insulating liquid constituting the liquid developer, and examples thereof include a silicone oil, such as KF96, KF4701, KF965, KS602A, KS603, KS604, KF41, KF54 and FA630 (produced by Shin-Etsu Silicone Co., Ltd.), TSF410, TSF433, TSF434, TSF451 and TSF437 (produced by Momentive Performance Materials Japan LLC.), and SH200 (produced by Toray Industries, Inc.), an aliphatic hydrocarbon, such as Isopar E, Isopar G, Isopar H and Isopar L (produced by Exxon Mobil Corp.), Cosmowhite P-60, Cosmowhite P-70 and Cosmowhite P-120 (produced by Cosmo Oil Lubricants Co., Ltd.), Diana Fresia W-8, Daphne Oil CP, Daphne Oil KP, Transformer Oil H, Transformer Oil G, Transformer Oil A, Transformer Oil B and Transformer Oil S (produced by Idemitsu Kosan Co., Ltd.), Shellsol 70 and Shellsol 71 (produced by Shell Oil Company), Amsco OMS and Amsco 460 (produced by American Mineral Spirits Co.), low-viscosity and high-viscosity liquid paraffin (produced by Wako Pure Chemical Industries, Ltd.), octane, isooctane, decane, isodecane, decalin, nonane, dodecane, isododecane, cyclohexane, cyclooctane and cyclodecane, a fatty acid triglyceride, a fatty acid monoglyceride, a fatty acid diglyceride, a decomposed product of a fatty acid triglyceride, such as glycerin and a fatty acid, a synthetic ester liquid, such as Prifer 6813 (produced by UNIQEMA) and DBE (produced by Invista Japan, Inc.), benzene, toluene, xylene, mesitylene and a fatty acid monoester, which may be used solely or in combination of plural kinds of them.

Among these, in the case where the liquid component contains a fatty acid monoester, the following advantages can be obtained. The fatty acid monoester referred therein means an ester of a fatty acid and a monohydric alcohol.

A fatty acid monoester has a significant plasticizing effect of plasticizing the resin material contained in the toner particles, and upon heating the resin material, the fatty acid monoester particularly easily softens the resin material and melts the same. Accordingly, upon fixing at a low temperature, the toner particles of the liquid developer of the embodiment of the invention are improved in low temperature fixing property as compared to toner particles of a liquid developer having been used in this field. Furthermore, a toner image formed with the liquid developer can be particularly improved in fixing strength. A fatty acid monoester is an environmentally benign component. Accordingly, load on the environments caused by leakage of the liquid developer outside an image forming apparatus and disposal of a used liquid developer can be reduced. As a result, an environmentally benign liquid developer can be provided.

The fatty acid component constituting the fatty acid monoester is not particularly limited, and examples thereof include an unsaturated fatty acid, such as oleic acid, palmitoleic acid, linoleic acid, α-linolenic acid, γ-linolenic acid, arachidonic acid, docosahexaenoic acid (DHA) and eicosapentaenoic acid (EPA), and a saturated fatty acid, such as butyric acid, lauric acid, caproic acid, caprylic acid, myristic acid, palmitic acid, stearic acid, arachidinic acid, behenic acid and lignoceric acid, which may be used solely or in combination of plural kinds of them.

Among these, in the case where the fatty acid monoester contains a saturated fatty acid as the fatty acid component, the fatty acid monoester is difficult to suffer deterioration (such as oxidation and decomposition), i.e., chemically stable. Accordingly, the toner particles containing the above-described fatty acid monoester are certainly prevented from suffering deterioration phenomenon, such as discoloration and degeneration, for a prolonged period of time, and thus the liquid developer is particularly excellent in long-term stability and storage stability. Upon fixing, a toner image formed contains the fatty acid monoester. As having been described, the fatty acid monoester containing a saturated fatty acid as a constitutional component is difficult to suffer deterioration, and therefore, even in the case where the toner image is exposed to an external atmosphere (such as light, heat and oxygen), the toner image is certainly prevented from suffering discoloration and can maintain the sharpness thereof for a prolonged period of time.

In the case where the fatty acid monoester contains a saturated fatty acid as the fatty acid component, a fatty acid having from 8 to 22 carbon atoms is preferably contained as the saturated fatty acid. According to the constitution, the toner particles are favorably plasticized with the fatty acid monoester, and even in the case where the fixing operation is carried out at a relatively low temperature, the toner particles can be firmly fixed to a recording medium.

The fatty acid monoester is an ester of a fatty acid and a monohydric alcohol, and the alcohol is preferably an alkyl alcohol having from 1 to 4 carbon atoms. According to the constitution, the toner particles are favorably plasticized with the fatty acid monoester, and even in the case where the fixing operation is carried out at a relatively low temperature, the toner particles can be firmly fixed to a recording medium. Furthermore, the liquid developer is improved in chemical stability, and thus the liquid developer is further excellent in storage stability and long-term stability. Examples of the alcohol include methanol, ethanol, propanol, butanol and isobutanol.

In the case where the liquid component contains a synthetic ester liquid, the aforementioned plasticizing effect can be significantly obtained, and the liquid developer can be particularly improved in low temperature fixing property and fixing characteristics. Moreover, a synthetic ester liquid is chemically stable, and thus the liquid developer can be improved in stability of the characteristics thereof for a prolonged period of time. In the case where the synthetic ester liquid is used in the liquid developer, it is not released as VOC (volatile organic compound) upon storing and forming an image, and the liquid developer becomes harmless to the human body and the environment.

### 2. Resin Material

The toner constituting the liquid developer is constituted by a material containing a resin material (which may be hereinafter simply referred to as a resin) as a major component.

In the embodiment of the invention, the resin (resin material) is not particularly limited, and for example, known resins may be used.

Among these, in the case where the resin material contains an ethylene copolymer, the resin material is favorably plasticized with the aforementioned liquid component. Accordingly, even in the case where the fixing operation is carried out at a relatively low temperature, the toner particles can be certainly fixed to a recording medium firmly, and a toner image obtained is particularly improved in fixing strength. The ethylene copolymer has high affinity with the above-described fatty acid monoester and the synthetic ester liquid. Accordingly, in the case where the fatty acid monoester and the synthetic ester liquid are used as the liquid component, the ethylene copolymer is swollen upon being plasticized with the liquid component to retain the liquid component certainly, and thus the liquid component can be prevented from being released to the insulating liquid. Consequently, the liquid developer can be improved in stability of the characteristics thereof for a prolonged period of time. The toner particles containing the ethylene copolymer can be certainly prevented from suffering deformation, aggregation and the like even in the case where the liquid developer is stored in an environment at a relatively high temperature. Examples of the ethylene copolymer include an ethylene-(meth)acrylic acid copolymer, an ethylene-vinyl acetate copolymer, a partially saponified product of an ethylene-vinyl acetate copolymer, and an ethylene-(meth)acrylate ester copolymer. Among these, in the case where the resin contains an ethylene-(meth) acrylic acid copolymer, the aforementioned advantages can be significantly obtained.

The resin may be a material that contains an ester bond in the chemical structure thereof. In the case where the resin contains the above-described material, the resin can be favorably plasticized with the liquid component. Accordingly, the toner particles are particularly liable to be melted by heating upon fixing. As a result, the toner particles containing the material having an ester bond in the liquid developer can be fixed firmly to a recording medium, and a toner image obtained is improved in fixing strength even in the case of fixing at relatively low temperature. In the case where the synthetic ester liquid or the fatty acid monoester is contained as the liquid component, in particular, the advantages can be significantly obtained. It is considered that the exhibition of the significant plasticizing effect is obtained since both the fatty acid monoester or the synthetic ester liquid and the aforementioned material contain an ester bond and have high chemical affinity with each other. In the case where a fatty acid triglyceride described later is contained as the insulating liquid, toner particles constituted by the resin that satisfies the aforementioned conditions are particularly improved in dispersibility in the insulating liquid owing to the similarity in chemical structure with the fatty acid triglyceride, and thus the toner particles can be further effectively prevented from suffering aggregation upon storing, whereby the liquid developer is particularly improved in storage stability. Examples of the resin having an ester bond in the chemical structure thereof include a polyester resin, a styrene-acrylate ester copolymer and a styrene-methacrylate ester copolymer. Among these, in the case where a polyester resin is used as the binder resin, the resulting image has high coloring property owing to the high transparency of the resin.

The melting point Tm (° C.) of the resin material is not particularly limited, and is preferably from 80 to 140° C., more preferably from 85 to 120° C., and further preferably from 85 to 115° C. According to the constitution, the toner particles can be certainly fixed to a recording medium upon fixing. Furthermore, even in the case where the fixing temperature upon fixing is relatively low, the toner particles can be favorably fixed to a recording medium. Moreover, the toner particles can be certainly prevented from suffering unintended deformation and aggregated upon storing. In the embodiment of the invention, the melting point may be measured, for example, according to JIS K7121 1987.

In the case where the resin (resin material) contains the ethylene copolymer, the Vicat softening temperature Tv (° C.) of the resin material is not particularly limited, and is preferably from 40 to 100° C., more preferably from 45 to 95° C., and further preferably from 50 to 90° C. According to the constitution, the toner particles can be certainly prevented from suffering aggregation and deformation thereof upon storing. In the embodiment of the invention, the Vicat softening point may be measured, for example, according to JIS K7026 1999.

In the case where the resin (resin material) contains the ethylene copolymer, the Vicat softening temperature Tv (° C.) and the melting point Tm (° C.) of the resin material preferably satisfy the relationship, Tm-Tv≦50, and more preferably satisfy the relationship, Tm-Tv≦40. According to the constitution, the toner particles can be certainly prevented from suffering aggregation and deformation upon storing while the liquid developer is particularly improved in low temperature fixing property, thereby improving particularly the liquid developer in storage stability.

In the case where the resin (resin material) contains the polyester resin, the glass transition temperature Tg (° C.) of the resin material is not particularly limited, and is preferably from 40 to 75° C., and more preferably from 45 to 70° C. According to the constitution, the toner particles can be certainly prevented from suffering aggregation and deformation upon storing. In the embodiment of the invention, the glass transition temperature may be measured according to JIS K7121.

In the case where the resin (resin material) contains the polyester resin, the glass transition temperature Tg (° C.) and the melting point Tm (° C.) of the resin material preferably satisfy the relationship, Tm-Tg≦80, and more preferably satisfy the relationship, Tm-Tg≦70. According to the constitution, the toner particles can be certainly prevented from suffering aggregation and deformation upon storing while the liquid developer is particularly improved in low temperature fixing property, thereby improving particularly the liquid developer in storage stability.

### 3. Colorant

The toner particles may contain a colorant. The colorant is not particularly limited, and for example, a pigment, a dye and the like having been known may be used.

### 4. Other Components

The toner particles may contain other components than those described above. Examples of the components include wax and magnetic powder having been known.

As the constitutional materials (components) constituting the toner particles, other materials than those described above, for example, zinc stearate, zinc oxide, cerium oxide, silica, titanium oxide, iron oxide, a fatty acid, a fatty acid metallic salt and the like may be used.

### Particle Diameter, etc. of Toner Particles

The toner particles constituted by the aforementioned materials preferably have an average particle diameter of from 0.7 to 3 μm, more preferably from 0.8 to 2.5 μm, and further preferably from 0.8 to 2 μm. In the case where the average particle diameter of the toner particles is in the above-described range, the toner particles can be reduced in fluctuation in properties among the particles, whereby a resolution of a toner image formed with the liquid developer can be sufficiently increased while maintaining the total high reliability of the liquid developer. Upon storing, furthermore, aggregation and deformation of the toner particles due to excessive plasticization by the liquid component can be surely prevented, and upon fixing, the toner particles is particularly easily melted and can be firmly fixed to a recording medium even at a relatively low temperature. Furthermore, the toner particles can be improved in dispersibility in the insulating liquid to improve the storage stability of the liquid developer. The average particle diameter referred herein means an average particle diameter by volume unless otherwise indicated.

The content of the toner particles in the liquid developer is preferably from 10 to 60% by weight, and more preferably from 20 to 50% by weight.

### Insulating Liquid

The insulating liquid will be described.

The insulating liquid is constituted by a liquid having an aniline point that is higher than that of the liquid component contained in the toner particles. As having been described, the toner particles constituting the liquid developer of the embodiment of the invention is liable to be plasticized owing to the liquid component contained. However, by using the liquid having a relatively high aniline point as the insulating liquid, the surface part of the toner particles can be certainly prevented from being plasticized excessively. As a result, the toner particles can be certainly prevented from suffering deformation and aggregation, and the liquid developer is improved in storage stability.

The aniline point of the insulating liquid may be higher than the aniline point of the liquid component contained in the toner particles, and preferably from 5 to 100° C., and more preferably from 5 to 70° C. According to the constitution, the toner particles can be certainly prevented from suffering deformation and aggregation, and the liquid developer is particularly improved in storage stability. Furthermore, in the case where the aniline point is in the range, members of an image forming apparatus can be prevented from being deteriorated with the insulating liquid, upon storing the liquid developer and forming an image. Furthermore, the viscosity of the liquid developer can be is in a favorable range, and thus upon forming an image, the toner particles electrophoresed quickly. Consequently, the liquid developer becomes suitable for high-speed image formation.

The aniline point AP (a) (° C.) of the liquid component contained in the toner particles and the aniline point AP (b) (° C.) of the insulating liquid preferably satisfy the relationship, 10≦AP(b)−AP(a)≦100, and more preferably satisfy the relationship, 10≦AP(b)−AP(a)≦60. According to the constitution, the toner particles can be certainly prevented from suffering aggregation and deformation while the liquid developer is particularly improved in low temperature fixing property, and the liquid developer can be particularly improved in storage stability.

In the liquid developer of the embodiment of the invention, the insulating liquid is a nonvolatile liquid. According to the constitution, the insulating liquid can be certainly prevented from being evaporated upon fixing, and thus a volatile organic compound (VOC) can be certainly prevented from being generated. As a result, the liquid developer particularly becomes harmless to humans and organisms. Furthermore, an environmentally benign liquid developer can be provided.

The initial boiling point of the insulating liquid is preferably 105° C. or more, and more preferably 140° C. or more. According to the constitution, the insulating liquid can further certainly prevented from being evaporated. As a result, the liquid developer particularly becomes harmless to humans and organisms. Furthermore, an environmentally benign liquid developer can be provided. The initial boiling point referred herein means a temperature, at which the first drop of the condensed distillate obtained by distilling a liquid under constant conditions, and in particular, a temperature that is obtained by carrying out a distillation test according to JIS K2254. In the case of a liquid constituted by only one kind of component, the initial boiling point is liable to be a temperature close to the boiling point thereof. In the case of a liquid constituted by plural kinds of components, the initial boiling point is liable to be a temperature close to the boiling point of the liquid having the lowest boiling point when no azeotrope occurs.

The insulating liquid used in the liquid developer of the embodiment of the invention may be any liquid that has an aniline point higher than that of the liquid component contained in the toner particles, and is nonvolatile, and examples thereof include those liquid described above.

Among the examples described above, in the case where the insulating liquid contains a fatty acid triglyceride, and the toner particles contain a synthetic ester liquid or a fatty acid monoester, the toner particles are particularly improved in dispersibility and the liquid developer is particularly improved in storage stability. The fatty acid triglyceride referred herein is a triester of glycerin and a fatty acid (triglyceride).

This is because the fatty acid triglyceride has high affinity with the synthetic ester liquid and the fatty acid monoester. Accordingly, the toner particles containing the synthetic ester liquid and the fatty acid monoester can be favorably dispersed in the insulating liquid containing the fatty acid triglyceride. The fatty acid triglyceride contained in the insulating liquid can dissolve out the synthetic ester liquid and the fatty acid monoester attached to the surface of the toner particles to reduce the content of the synthetic ester liquid and the fatty acid monoester on the surface of the toner particles, whereby the surface part of the toner particles can be certainly prevented from being plasticized excessively. Accordingly, the toner particles can be certainly prevented from suffering aggregation and deformation upon storing.

Furthermore, the fatty acid triglyceride is an environmentally benign component, and thus the load of the insulating liquid on environment due to leakage of the insulating liquid outside an image forming apparatus and disposal of the used liquid developer can be reduced. As a result, an environmentally benign liquid developer can be provided.

The fatty acid component contained in the fatty acid triglyceride is not particularly limited, and examples thereof include a saturated fatty acid, such as butyric acid, caproic acid, caprylic acid, capric acid, lauric acid, myristic acid, palmitic acid, stearic acid, arachic acid, behenic acid and lignoceric acid, a monobasic unsaturated fatty acid, such as crotonic acid, myristoleic acid, palmitoleic acid, oleic acid, elaidic acid, vaccenic acid, gadoleic acid, erucic acid and nervonic acid, a polybasic unsaturated fatty acid, such as linoleic acid, α-linolenic acid, γ-linolenic acid, arachidonic acid, eleostearic acid, stearidonic acid, arachidonic acid, clupanodonic acid, docosahexaenoic acid (DHA) and eicosapentaenoic acid (EPA), and derivatives thereof, which may be used solely or in combination of plural kinds of them.

Among these, in the case where fatty acid triglyceride contains a saturated fatty acid component, the chemical stability of the liquid developer and the electric insulating property of the insulating liquid can be maintained at high levels. Among the saturated fatty acids, a saturated fatty acid having from 6 to 22 carbon atoms in the molecule of the saturated fatty acid component is preferred, a saturated fatty acid having from 8 to 20 carbon atoms is more preferred, and a saturated fatty acid having from 10 to 18 is further preferred. The aforementioned advantages can be exhibited further significantly in the case where the saturated fatty acid component is contained.

In the case where the fatty acid triglyceride contains an unsaturated fatty acid component, the fatty acid triglyceride can contribute to improvement in long-term storage stability of the toner image obtained through image formation. It is considered that this is because of the following mechanisms. The unsaturated fatty acid component is cured by itself upon oxidation thereof. Accordingly, in the case where a liquid developer containing a fatty acid triglyceride containing an unsaturated fatty acid is used to form and fix a toner image on a recording medium, the fatty acid triglyceride remaining in the toner image along with the toner particles can undergo oxidation polymerization with oxygen or the like in the air, whereby the toner particles can be firmly adhered to each other, and the toner particles and the recording medium can be firmly adhered to each other. The unsaturated fatty acid component of the fatty acid triglyceride can undergo oxidation polymerization while covering the surface of the toner image, and therefore, a protective film of the cured fatty acid triglyceride can be formed on the surface of the toner image. Because of the aforementioned factors, the toner image can be prevented from suffering deterioration due to external physical force, such as friction, the air, light and the like to have excellent long-term stability.

The unsaturated fatty acid triglyceride can be obtained efficiently from a naturally-derived oil as an oil derived from vegetables, such as sunflower oil, safflower oil, rice oil, rice bran oil, rapeseed oil, olive oil, sesame oil, canola oil, soybean oil, linseed oil and caster oil, and an oil derived from animals, such as beef tallow oil.

The content of the fatty acid triglyceride in the insulating liquid is preferably from 20 to 90% by weight, more preferably from 30 to 80% by weight, and further preferably from 40 to 70% by weight. According to the constitution, the dispersibility of the toner particles in the liquid developer is particularly improved, and the chemical stability of the liquid developer can be particularly improved.

In the case where the insulating liquid contains an aliphatic hydrocarbon, the following advantages can be obtained. An aliphatic hydrocarbon generally has a high electric resistance and is chemically stable. Accordingly, the liquid developer using an aliphatic hydrocarbon is particularly excellent in developing property and transferring property, and a toner image obtained therewith becomes sharp with less defects. An aliphatic hydrocarbon is a liquid having less hygroscopicity. Accordingly, in the case where the insulating liquid contains the aliphatic hydrocarbon, the insulating liquid can be favorably prevented from absorbing moisture upon storing, whereby the insulating liquid can be prevented from suffering modification (deterioration). The aliphatic hydrocarbon is chemically stable by itself and suffers less modification (deterioration) upon storing. Therefore, the liquid developer can be particularly improved in long-term storage stability. Furthermore, in the case where the liquid component in the toner particles contains the fatty acid monoester and the synthetic ester liquid, the following advantages can be obtained when the insulating liquid contains a silicone oil. The aliphatic hydrocarbon is liable to permeate a recording medium, such as paper. Accordingly, the insulating liquid containing the aliphatic hydrocarbon can quickly permeate the recording medium upon fixing. The aliphatic hydrocarbon has high affinity with the fatty acid monoester and the synthetic ester liquid. Accordingly, in the case where the liquid component in the toner particles contains the fatty acid monoester and the synthetic ester liquid, the toner particles having been plasticized with the liquid component and melted favorably penetrate into the recording medium along with the aliphatic hydrocarbon to attain anchoring effect in that state, thereby being fixed firmly to the recording medium. Consequently, by using the liquid developer, even in the case where the fixing operation is carried out at a high speed and a low temperature, the toner particles can be easily made in contact with each other and can be melted bound firmly upon fixing, and the resulting toner image is particularly improved in fixing strength.

In the case where the insulating liquid contains a silicone oil, the following advantages can be obtained. A silicone oil is an organic compound having a siloxane bond as a skeleton. A silicone oil generally has a high electric resistance. In the case where a silicone oil is used as the insulating liquid, accordingly, the liquid developer has a particularly high electric resistance and is improved in transferring property and developing property of a toner image. The silicone oil has various values in viscosity depending on the kinds thereof, and thus the viscosity of the liquid developer can be optimized by selecting the silicon oil. The silicone oil is generally stable chemically and is less harmful to human health. Accordingly, the liquid developer can be favorably prevented the insulating liquid from being deteriorated upon storing to provide excellent environmental stability. Furthermore, the liquid developer is safe even in the case where the insulating liquid is leaked outside an image forming apparatus.

In the case where the liquid developer contains the silicone oil as the insulating liquid and contains the fatty acid monoester or the synthetic ester liquid as the liquid component in the toner particles, the fixing operation can be carried stably out at a high-speed and a low temperature, and the resulting toner image is particularly improved in fixing strength. It is considered that this is because of the following mechanisms. The silicone oil has low affinity with the fatty acid monoester, the synthetic ester liquid and the resin constituting the toner particles. Accordingly, in the liquid developer containing the silicone oil, the fatty acid monoester and the synthetic ester liquid, which have high affinity with the resin material, are retained selectively by the toner particles, so as to exhibit the plasticizing effect particularly favorably upon fixing. Consequently, even in the case where the fixing operation is carried out at a high speed and a relatively low temperature, the toner image can be fixed firmly to a recording medium.

The liquid developer may contain a dispersant capable of improving dispersibility of the toner particles.

Examples of the dispersant include a polymer dispersant, such as polyvinyl alcohol, carboxymethyl cellulose, polyethylene glycol, Adisper PB821 (a trade name, produced by Ajinomoto Co., Inc.), Solsperse (a trade name, produced by Lubrizol Corp. Japan), a polycarboxylic acid and a salt thereof, a polyacrylic acid metallic salt (such as a sodium salt), a polymethacrylic acid metallic salt (such as sodium salt), a polymaleic acid metallic salt (such as sodium salt), an acrylic acid-maleic acid copolymer metallic salt (such as a sodium salt), a polystyrenesulfonic acid metallic salt (such as a sodium salt) and a polyamine-fatty acid polycondensate, a clay mineral, silica, calcium triphosphate, a tristearic acid metallic salt (such as an aluminum salt), a distearic acid metallic salt (such as an aluminum salt and a barium salt), a stearic acid metallic salt (such as a calcium salt, a lead salt and a zinc salt), a linolenic acid metallic salt (such as a cobalt salt, a manganese salt, a lead salt and a zinc salt), an octanoic acid metallic salt (such as an aluminum salt, a calcium salt and a cobalt salt), an oleic acid metallic salt (such as a calcium salt and a cobalt salt), a palmitic acid metallic salt (such as a zinc salt), a dodecylbenzenesulfonic acid metallic salt (such as a sodium salt), a naphthenic acid metallic salt (such as a calcium salt, a cobalt salt, a manganese salt, a lead salt and a zinc salt) and an abietic acid metallic salt (such as a calcium salt, a cobalt salt, a manganese salt, a lead salt and a zinc salt).

In the case where a polyamine-fatty acid polycondensate is used among the dispersants, the polyamine-fatty acid polycondensate can be attached to the surface of the toner particles, whereby the toner particles can be prevented from suffering unintended aggregation to further improve charging property in the toner particles.

In the case where a polyamine-fatty acid polycondensate is used, the content of the polyamine-fatty acid polycondensate in the liquid developer is preferably from 0.5 to 7.5 parts by weight, and more preferably from 1 to 5 parts by weight, per 100 parts by weight of the toner particles. According to the constitution, the advantages obtained by using the polyamine-fatty acid polycondensate can be exhibited further significantly.

The insulating liquid may contain an antioxidant.

The liquid developer (insulating liquid) may contain a charge controlling agent.

Examples of the charge controlling agent include a metallic oxide, such as zinc oxide, aluminum oxide and magnesium oxide, a metallic salt of benzoic acid, a metallic salt of salicylic acid, a metallic salt of an alkylsalicylic acid, a metallic salt of catechol, a metal-containing bisazo dye, a nigrosine dye, a tetraphenylborate derivative, a quaternary ammonium salt, an alkylpyridinium salt, chlorinated polyester and nitrohumic acid.

The insulating liquid preferably has an electric resistance at room temperature (20° C.) of 1.0×10¹¹ Ω·cm or more, more preferably 1.0×10¹² Ω·cm or more, and further preferably 2.0×10¹² Ω·cm or more.

The insulating liquid preferably has a dielectric constant of 3.5 or less.

The viscosity (measured with a vibration viscometer at 25° C. according to JIS Z8809) of the liquid developer constituted by the aforementioned components (i.e., the liquid developer of the invention) is preferably 1,000 mPa·s or less. According to the constitution, the liquid developer favorably permeates the recording medium, whereby the fixing property of the toner particles to the recording medium is improved. Furthermore, an image obtained on the recording medium becomes sharp without unevenness, and moreover, the liquid developer becomes suitable particularly for high-speed image formation.

The electric resistance at room temperature (20° C.) of the liquid developer constituted by the aforementioned components (i.e., the liquid developer of the invention) is preferably 1.0×10¹¹ Ω·cm or more, and more preferably 1.0×10¹² Ω·cm or more.

### Production Method of Liquid Developer

An embodiment of the production method of the liquid developer of the invention will be described.

The production method of the liquid developer of the embodiment mainly contains a resin solution preparing step of preparing a resin solution having a resin material dissolved in a first liquid, and a resin depositing step of adding a second liquid having an aniline point higher than that of the first liquid to the resin solution, whereby the resin material is deposited in the resin solution to form resin fine particles (toner particles). The production method of the liquid developer of the embodiment contains, before the resin solution preparing step, a kneading step of kneading the resin and a colorant to form a kneaded product, and a pulverizing step of pulverizing the kneaded product to obtain a pulverized product. According to the constitution, the above-described liquid developer can be obtained easily and certainly, and the toner particles contain the liquid component easily and certainly. In the case where the resin material is deposited by using the insulating liquid to form the toner particles in this manner, there is no necessity of pulverizing the constitutional materials of the toner particles, and thus an energy saving production method of the liquid developer can be provided. The first liquid and the second liquid used for depositing the resin material in the embodiment are nonvolatile liquids. Accordingly, the first liquid and the second liquid can be used as the constitutional components of the liquid developer, and there is no necessity of removing unnecessary liquids, such as distillation. Accordingly, the production method of the liquid developer is excellent in productivity and effectively utilizes the resources.

### Kneading Step

The resin material and the colorant are kneaded to obtain a kneaded product.

The raw material to be kneaded contains the resin material and the colorant as described above. By using the colorant in the raw material, particularly, the air contained in the raw material (particularly, the air entrained in the colorant) can be effectively removed in this step, and thus bubbles can be effectively prevented from being mixed (remaining) in the toner particles. Furthermore, by kneading the resin material and the colorant uniformly, the colorant can be particularly improved in dispersibility and solubility in the resin solution described later, whereby the resulting toner particles contain the colorant dispersed therein particularly uniformly. The components of the raw material to be kneaded are preferably mixed in advance.

The kneading operation of the raw material can be carried out by using various kneading machines, such as a continuous type two-roll kneading extruder, a kneader, a batch type three-roll mill, a continuous type two-roll mill, a wheel mixer and a blade type mixer. Among these, a continuous type two-roll kneading extruder is preferably used as the kneading machine. According to the constitution, the raw material can be effectively kneaded, and the air contained in the raw material can be removed.

The raw material to be kneaded may contain the above-described dispersant. According to the constitution, the colorant can be particularly improved in dispersibility and solubility in the resin solution described later, whereby the resulting toner particles contain the colorant dispersed therein particularly uniformly.

The raw material to be kneaded may contain a part or the whole of the liquid component constituting the above-described toner particles. According to the constitution, the resulting liquid developer can easily and certainly contain the liquid component in the toner particles.

### Pulverizing Step

The kneaded product as described above is then pulverized to obtain a pulverized product. By pulverizing the kneaded product, the resin solution described later can be obtained as a uniform solution relatively easily. As a result, the size of the toner particles contained in the liquid developer finally obtained can be reduced, whereby the liquid developer can be favorably used for forming an image with high resolution.

The method of pulverization is not particularly limited, and can be carried out by using various pulverizing machines and crushing machines, such as a ball mill, a vibration mill, a jet mill and a pin mill.

The pulverizing step may be carried out by dividing into plural steps (for example, a coarsely pulverizing step and a finely pulverizing step). Furthermore, such a step as a classifying step may be carried out depending on necessity after the pulverizing step. In the classifying step, for example, a sieve, an air-flow classifier and the like may be used.

### Resin Solution Preparing Step

A resin solution having the resin material dissolved in the first liquid is then prepared.

The first liquid has an aniline point that is lower than that of the second liquid. In other words, the first liquid generally has higher solubility of the resin material than the second liquid.

The first liquid generally contains a part or the while of the liquid component of the toner particles of the liquid developer to be produced. By dissolving the resin material in the first liquid containing the constitutional component of the liquid component, the toner particles certainly contains the constitutional component of the liquid component contained in the first liquid.

The aniline point of the first liquid is not particularly limited as far as it is lower than the aniline point of the second liquid, and specifically is preferably 30° C. or less, and more preferably 0° C. or less. According to the constitution, the resin material can be easily and certainly dissolved, and the resin fine particles can be effectively deposited. As a result, the resulting liquid developer has a particularly narrow particle size distribution of the toner particles, and the toner particles certainly contain the liquid component.

The resin solution may be prepared in any method, and for example, can be obtained by mixing the pulverized product and the first liquid with an agitating machine, such as a high-speed agitating machine. According to the method, the resin material contained in the pulverized product can be certainly dissolved in the first liquid. The colorant can also be certainly dispersed and dissolved in the first liquid.

The agitating machine used for preparing the resin solution may be any type, and examples thereof include an attritor, a ball mill, a planetary ball mill, a bead mill, a sand mill, a high-speed mixer and a homogenizer.

In this step, an additional resin material may be mixed in addition to the pulverized product. According to the procedure, the concentration of the colorant of the toner particles in the liquid developer to be obtained can be easily controlled.

Upon mixing the pulverized product and the first liquid in this step, these materials may be heated. According to the procedure, the resin material can be certainly dissolved in the first liquid. In this case, the temperature of the materials constituting the resin solution is preferably from 80 to 160° C., and more preferably from 90 to 140° C. According to the procedure, the resin material can be dissolved in the first liquid easily and certainly. The components contained in the resin solution can be certainly prevented from suffering modification, vaporization or the like at the temperature of the materials within the range.

The solid content in the resin solution is not particularly limited, and is preferably from 20 to 60% by weight, and more preferably from 30 to 50% by weight. In the case where the solid content is in the range, the viscosity characteristics of the resin solution can be improved while the resin material is certainly dissolved in the first liquid. Furthermore, the concentration of the toner particles in the resulting liquid developer can be sufficiently increased.

The first liquid may contain a part or the whole of the liquid component as described above and is capable of dissolving the resin material, and the first liquid may contain another component. For example, a part of the insulating liquid constituting the above-described liquid developer may be contained. Furthermore, a dispersant or the like may be contained.

### Resin Depositing Step

The second liquid having an aniline point higher than that of the first liquid is added to the resin solution, whereby the resin material is deposited in the resin solution to form resin fine particles (toner particles). Specifically, the resin material is deposited by adding the second liquid, which has lower affinity (solubility) with the resin material than the first liquid, to the resin solution. According to the procedure, a liquid developer having toner particles dispersed in an insulating liquid can be obtained. The second liquid generally constitutes mainly the insulating liquid of the liquid developer. The resin fine particles thus obtained in this manner contain the first liquid. More specifically, upon depositing the resin material as the resin fine particles by adding the second liquid, the resin material is deposited while entraining apart of the first liquid, which has higher affinity (solubility) therewith. As having been described, the resin fine particles are deposited after once dissolving the resin material in the first liquid, whereby the resin fine particles contain the constitutional component contained in the first liquid. The constitutional component of the first liquid contained in the resin fine particles is thus uniformly contained in the resin fine particles. By depositing the resin fine particles in this manner, resin fine particles (toner particles) having an intended particle diameter with a narrow particle size distribution can be obtained.

The second liquid has an aniline point that is higher than that of the first liquid, and the constitutional components of the insulating liquid of the liquid developer described above can be used.

The aniline point of the second liquid is not particularly limited as far as it is higher than the aniline point of the first liquid, and specifically is preferably from 10 to 140° C., and more preferably from 10 to 110° C. According to the constitution, the resin material can be dissolved easily and certainly, and the resin fine particles can be efficiently deposited. As a result, the liquid developer obtained has a particularly narrow particle size distribution of the toner particles.

The aniline point AP(A) (° C.) of the first liquid and the aniline point AP(B) (° C.) of the second liquid preferably satisfy the relationship, 10≦AP(B)−AP(A)≦100, and more preferably satisfy the relationship, 10≦AP(B)−AP(A)≦80. According to the constitution, the resin fine particles can be gradually deposited in this step to obtain a particularly narrow particle size distribution of the resin fine particles. Furthermore, in the case where the first liquid and the second liquid satisfy the relationship, the resin fine particles can be efficiently obtained.

The addition of the second liquid to the resin solution may be carried out in any method, and it is preferred that the second liquid is added dropwise to the resin solution under agitating. According to the procedure, the second liquid can be certainly prevented from suffering concentration unevenness in the resin solution, whereby the resin particles having a particularly uniform size can be obtained.

The agitation operation of the resin solution may be carried out with any device, and a device capable of applying a shearing force at a high speed is preferred, examples of which include a planetary mixer, a homogenizer and a homomixer. According to the procedure, the second liquid added can be uniformly disperse and dissolved quickly, whereby the second liquid can be certainly prevented from suffering concentration unevenness. Also, disintegration of the resin fine particles once formed can be surely prevented while the resin fine particles are efficiently precipitated. As a result, the resin fine particles with a small distribution in the shape and the particle size between the particles can be efficiently obtained.

The temperature of the materials in this step is preferably from 5 to 160° C., and more preferably from 10 to 150° C. According to the procedure, the liquid developer can be obtained easily and certainly while preventing the materials from suffering modification and decomposition.

The temperature of the resin solution in this step may not be constant. For example, the temperature of the resin solution may be gradually decreased. According to the procedure, the solubility of the resin material in the resin solution can be gradually decreased, thereby facilitating deposition of the resin fine particles. Accordingly, the production method of the liquid developer is particularly improved in productivity. In this case, the temperature of the resin solution may be decreased upon adding the second liquid, or the temperature of the resin solution may be decreased after adding the second liquid.

A charge controlling agent, a dispersant or the like may be added in this step. These materials may be added before or after adding the second liquid and may be added simultaneously with the addition of the second liquid.

A liquid may be added after adding the second liquid. According to the procedure, the concentrations of the insulating liquid and the toner particles in the liquid developer can be easily controlled. In this case, the liquid added may have the same formulation as the first liquid or the second liquid or may have a different formulation therefrom.

The resin fine particles are added after adding the second liquid, and then the liquid having the resin fine particles dispersed therein may be replaced with another liquid to produce the liquid developer. In this case, a part of the liquid for dispersing the resin fine particles may be replaced, or the whole of the liquid may be replaced.

### Image Forming Apparatus

A preferred embodiment of the image forming apparatus according to an embodiment of the invention will be described. The image forming apparatus of the embodiment of the invention forms a color image on a recording medium by using a liquid developer according to the embodiment of the invention having been described above.

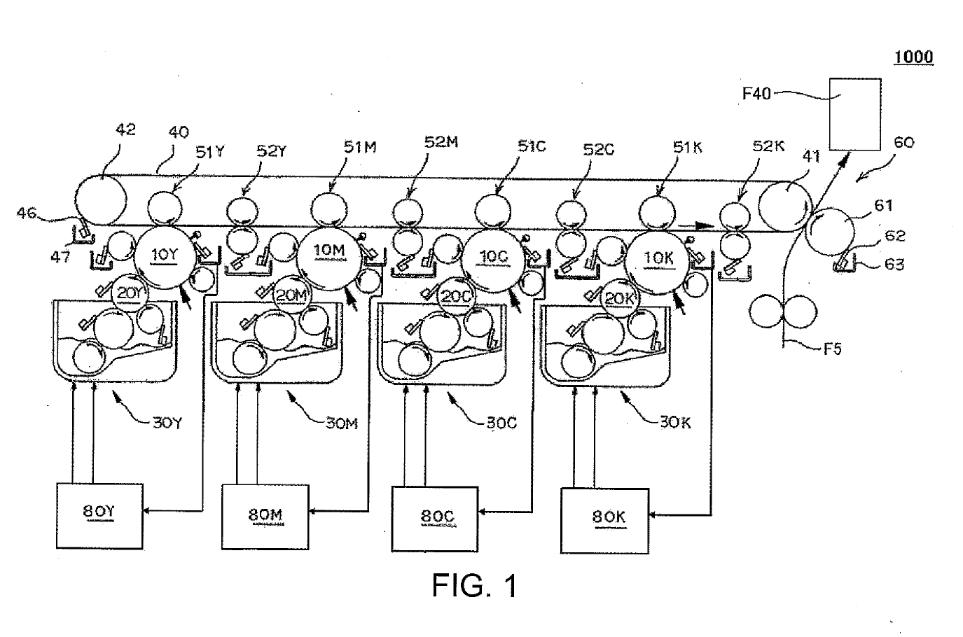

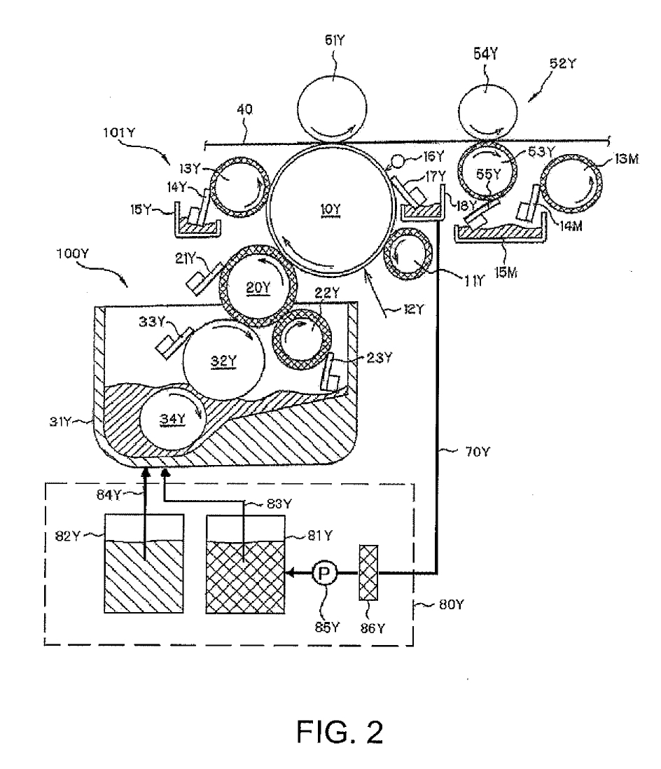

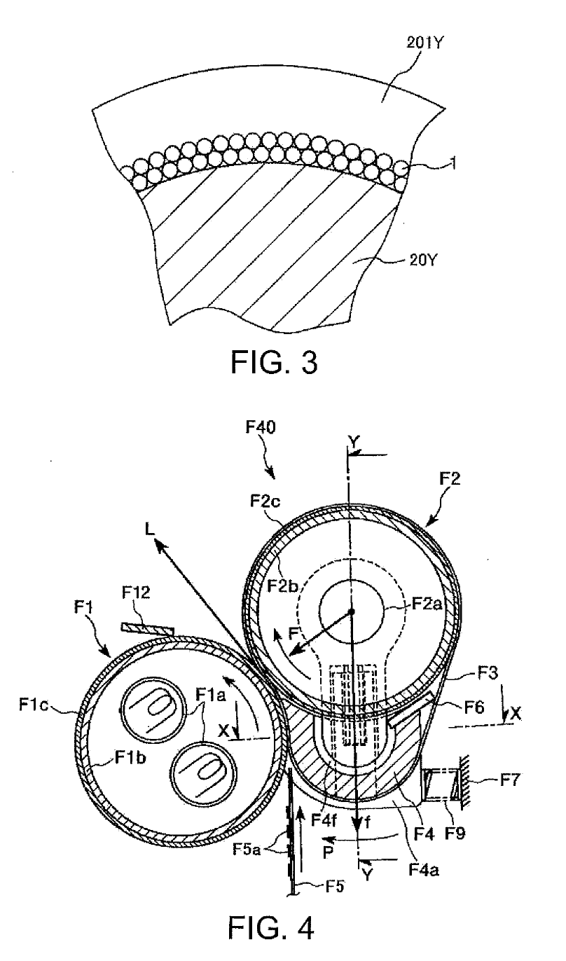

FIG. 1 is a schematic illustration showing an example of an embodiment of an image forming apparatus, to which a liquid developer according to an embodiment of the invention is applied. FIG. 2 is an enlarged illustration of a part of the image forming apparatus shown in FIG. 1. FIG. 3 is a schematic diagram showing the state of the toner particles in a liquid developer layer on a developing roller. FIG. 4 is a cross sectional view showing an example of the fixing device applied to the image forming apparatus shown in FIG. 1.

An image forming apparatus 1000 has, as shown in FIGS. 1 and 2, four developing parts 30Y, 30M, 30C and 30K, an intermediate transferring part 40, a secondary transferring unit (secondary transferring part) 60, a fixing part (fixing device) F40 and four liquid developer feeding parts 80Y, 80M, 80C and 80K.

The developing parts 30Y, 30M and 30C have a function of developing latent images with a yellow liquid developer (Y), a magenta liquid developer (M) and a cyan liquid developer (C) to form monochrome images corresponding to the colors, respectively. The developing part 30K has a function of developing a latent image with a black liquid developer (K) to form a black (K) monochrome image.

The developing parts 30Y, 30M, 30C and 30K have the same constitutions, and therefore, the developing part 30Y is described below.

The developing part 30Y has, as shown in FIG. 2, a photoreceptor 10Y as an example of an image carrying member, and has, along the rotation direction of the photoreceptor 10Y, a charging roller 11Y, an exposing unit 12Y, a developing unit 100Y, a photoreceptor squeezing device 101Y, a primary transfer backup roller 51Y, a destaticizing unit 16Y, a photoreceptor cleaning blade 17Y and a developer recovering part 18Y.

The photoreceptor 10Y has a tubular substrate having on an outer peripheral surface thereof a photoreceptor layer, and is rotatable with the center axis thereof as the center. In this embodiment, the photoreceptor 10Y is rotatable clockwise as shown by the arrow in FIG. 1.

A liquid developer is fed to the photoreceptor 10Y from the developing unit 100Y described later, and a layer of the liquid developer is formed on the surface thereof.

The charging roller 11Y is a device for charging the photoreceptor 10Y, and the exposing unit 12Y is a device for forming a latent image on the charged photoreceptor 10Y by radiating laser light. The exposing unit 12Y has a semiconductor laser, a polygonal mirror, an F-θ lens and the like, and irradiates the photoreceptor 10Y with laser light modulated based on image signals input from a host computer, such as a personal computer and a word processor, which is not shown in the figure.

The developing unit 100Y is a device for developing the latent image formed on the photoreceptor 10Y with the liquid developer according to an embodiment of the invention. The developing unit 100Y will be described in detail later.

The photoreceptor squeezing device 101Y is disposed to face the photoreceptor 10Y on the downstream side in the rotation direction with respect to the developing unit 100Y, and is constituted by a photoreceptor squeezing roller 13Y, a cleaning blade 14Y pressed onto the photoreceptor squeezing roller 13Y for removing the liquid developer attached to the surface of the photoreceptor squeezing roller 13Y, and a developer recovering part 15Y housing the liquid developer thus removed with the cleaning blade 14Y. The photoreceptor squeezing device 101Y has a function of recovering an excessive carrier (insulating liquid) and an unnecessary fogging toner from the developer having been developed on the photoreceptor 10Y to improve the proportion of the toner particles in the developed image.

A primary transfer backup roller 51Y is a device for transferring the monochrome image formed on the photoreceptor 10Y to the intermediate transferring part 40 described later.

The destaticizing unit 16Y is a device for removing remaining charge on the photoreceptor 10Y after transferring the intermediate transfer image to the intermediate transferring part 40 described later with the primary transfer backup roller 51Y.

The photoreceptor cleaning blade 17Y is a rubber member pressed onto the surface of the photoreceptor 10Y and has a function of scraping and removing the liquid developer remaining on the photoreceptor 10Y after transferring the image to the intermediate transferring part 40 described later with the primary transfer backup roller 51Y.

The developer recovering part 18Y has a function of recovering the liquid developer thus removed with the photoreceptor cleaning blade 17Y.

The intermediate transferring part 40 is an endless elastic belt member, which is wound and stretched on a belt driving roller 41 and a tension roller 42 and rotationally driven with the belt driving roller 41 through contact with the primary transfer backup rollers 51Y, 51M, 51C and 51K and the photoreceptors 10Y, 10M, 10C and 10K.

Monochrome images of plural colors formed in the developing parts 30Y, 30M, 30C and 30K are transferred sequentially to the intermediate transfer part 40 with the primary transfer backup rollers 51Y, 51M, 51C and 51K, and the monochrome images of the plural colors are superimposed on each other. According to the operation, a full color developed image (intermediate transfer image) is formed on the intermediate transfer part 40.

The intermediate transfer part 40 retains the monochrome images, which are formed on the plural photoreceptors 10Y, 10M, 10C and 10K and then secondarily transferred sequentially to the intermediate transfer part 40, and then secondarily transfers the images at one time to a recording medium F5, such as paper, film and cloth. The recording medium F5 may be a sheet material having rough surface due to fibrous materials thereof, and the elastic belt member is used as the intermediate transfer part 40 for improving the secondary transfer property by following the rough surface of the sheet material upon secondarily transferring the toner image to the recording medium F5.

A cleaning device containing an intermediate transfer part cleaning blade 46 and a developer recovering part 47 is disposed on the side of the tension roller 42, which stretches the intermediate transfer part 40 along with the belt driving roller 41.

The intermediate transfer part cleaning blade 46 has a function of scraping and removing the liquid developer attached to the intermediate transfer part 40 after transferring the image to the recording medium F5 with a secondary transfer roller 61.

The developer recovering part 47 has a function of recovering the liquid developer removed with the intermediate transfer part cleaning blade 46.

An intermediate transfer part squeezing device 52Y is disposed on the downstream side of the primary transfer backup roller 51Y in the moving direction of the intermediate transfer part 40.

The intermediate transfer part squeezing device 52Y is provided as a device for removing an excessive amount of the liquid developer transferred to the intermediate transfer part 40 in the case where the liquid developer transferred is not in a favorable dispersed state.

The intermediate transfer part squeezing device 52Y is constituted by an intermediate transfer part squeezing roller 53Y, an intermediate transfer part backup roller 54Y disposed to face the intermediate transfer part squeezing roller 53Y with the intermediate transfer part 40 intervening between them, an intermediate transfer part cleaning blade 55Y pressed onto the intermediate transfer part squeezing roller 53Y to clean the surface thereof, and a developer recovering part 15M.

The intermediate transfer part squeezing device 52Y has a function of recovering an excessive amount of the carrier from the developer primarily transferred to the intermediate transfer part 40 to increase the content of the toner particles in the developed image, and a function of recovering an unnecessary fogging toner. The developer recovering part 15M is a recovering mechanism for the carrier recovered by the cleaning blade 14M of the photoreceptor squeezing roller of magenta color disposed on the downstream side in the moving direction of the intermediate transfer part 40, and is also used as a recovering mechanism for the carrier recovered by the intermediate transfer part squeezing cleaning blade 55Y of the intermediate transfer part squeezing roller 53Y. Accordingly, the developer recovering parts 15M, 15C and 15K (the developer recovering parts 15C and 15K are not shown in the figures) of the image carrying member squeezing devices of the second or later colors in the moving direction of the intermediate transfer part 40 are used respectively as the developer recovering parts of the intermediate transfer part squeezing devices 52Y, 52M and 52C disposed in the downstream side of the preceding primary transfer backup rollers 51Y, 51M and 51C in the moving direction of the intermediate transfer part 40, whereby the intervals of them can be maintained constant, and the structure is simplified to enable miniaturization.

The secondary transfer unit 60 has a secondary transfer roller 61 disposed to face the belt driving roller 41 with the intermediate transfer part 40 intervening between them, and has a cleaning device containing a cleaning blade 62 for the secondary transfer roller 61 and a developer recovering part 63.

In the secondary transfer unit 60, the recording medium F5 is transported and fed according to the timing when the intermediate transfer image formed by superimposing the monochrome images on the intermediate transfer part 40 reaches the transfer position of the secondary transfer unit 60, and thus the intermediate transfer image is secondarily transferred to the recording medium F5.

The toner image (transferred image) F5a thus transferred to the recording medium F5 in the secondary transfer unit 60 is transported to the fixing part F40 and fixed therein.

The cleaning blade 62 has a function of scraping and removing the liquid developer attached to the secondary transfer roller 61 after transferring the image to the recording medium F5 with the secondary transfer roller 61.

The developer recovering part 63 has a function of recovering the liquid developer removed with the cleaning blade 62.

The developing units 100Y, 100M, 100C and 100K will be described in detail below. The developing unit 100Y will be described as a representative example.

The developing unit 100Y has, as shown in FIG. 2, a liquid developer storing part 31Y, a coating roller 32Y, a restricting blade 33Y, a developer agitating roller 34Y, a developing roller 20Y, a developing roller cleaning blade 21Y and a developer compressing roller (compressing unit) 22Y.

The liquid developer storing part 31Y has a function of storing the liquid developer for developing a latent image formed on the photoreceptor 10Y.

The coating roller 32Y has a function of feeding the liquid developer to the developing roller 20Y.

The coating roller 32Y is a so-called anilox roller, which is a metallic roller, such as an iron roller, having grooves formed uniformly and helically on the surface thereof and having been plated with nickel, and has a diameter of about 25 mm. In this embodiment, plural grooves are formed slantwise with respect to the rotation direction of the coating roller 32Y by a cutting process, a rolling process or the like. The coating roller 32Y is in contact with the liquid developer while rotating clockwise to retain the liquid developer stored in the liquid developer storing part 31Y in the grooves, and transports the retained liquid developer to the developing roller 20Y.

The restricting blade 33Y is in contact with the surface of the coating roller 32Y to restrict the amount of the liquid developer on the coating roller 32Y. Specifically, the restricting blade 33Y scrapes the excessive liquid developer on the coating roller 32Y to quantitate the liquid developer on the coating roller 32Y, which is to be fed to the developing roller 20Y. The restricting blade 33Y is formed of urethane rubber as an elastic material and supported with a restricting blade supporting member formed of a metal, such as iron. The restricting blade 33Y is provided on the side where the coating roller 32Y is rotated to come out from the liquid developer as viewed from the vertical plane A (i.e., on the left side as viewed from the vertical plane A in FIG. 2). The restricting blade 33Y has a rubber hardness of about 77 according to JIS-A, and the hardness of the restricting blade 33Y at the part in contact with the surface of the coating roller 32Y (about 77) is lower than the hardness of the developing roller 20Y described later at the part in contact with the surface of the coating roller 32Y (about 85). The excessive liquid developer thus scraped is recovered to the liquid developer storing part 31Y for reuse.

The developer agitating roller 34Y has a function of agitating the liquid developer to form a uniform dispersed state. By using the developer agitating roller 34Y, even in the case where plural toner particles 1 are aggregated, the respective toner particles 1 can be favorably dispersed. In the case where the liquid developer that has been once used is reused, in particular, the toner particles 1 can be favorably dispersed.

In the liquid developer storing part 31Y, the toner particles 1 in the liquid developer have positive charge, and the liquid developer in a uniform dispersed state by agitating with the developer agitating roller 34Y is drawn up from the liquid developer storing part 31Y through rotation of the coating roller 32Y, and then fed to the developing roller 20Y after restricting the amount of the liquid developer with the restricting blade 33Y.

The developing roller 20Y retains the liquid developer and transports the liquid developer to the developing position facing the photoreceptor 10Y for developing the latent image carried on the photoreceptor 10Y with the liquid developer.

The developing roller 20Y has a liquid developer layer 201Y formed on the surface thereof by feeding the liquid developer from the coating roller 32Y.

The developing roller 20Y has an inner core constituted by a metal, such as iron, having thereon an electroconductive elastic layer, and has a diameter of about 20 mm. The elastic layer has a two-layer structure containing an urethane rubber layer having a rubber hardness of about 30 according to JIS-A and a thickness of about 5 mm as an inner layer, and an urethane rubber layer having a rubber hardness of about 85 according to JIS-A and a thickness of about 30 mm as a surface (outer) layer. The developing roller 20Y is in contact with the coating roller 32Y and the photoreceptor 10Y with the surface layer as a contact part under pressure in an elastically deformed state.

The developing roller 20Y is rotatable with the center axis thereof as the center, and the center axis is positioned downward with respect to the center rotation axis of the photoreceptor 10Y. The developing roller 20Y is rotated in the direction (i.e., the anticlockwise direction in FIG. 2) opposite to the rotation direction (i.e., the clockwise direction in FIG. 2) of the photoreceptor 10Y. An electric field is formed between the developing roller 20Y and the photoreceptor 10Y upon developing the latent image formed on the photoreceptor 10Y.

The developer compressing roller 22Y is a device having a function of making the liquid developer retained by the developing roller 20Y into a compressed state. In other words, the developer compressing roller 22Y is a device having a function of applying an electric field having the same polarity as the toner particles 1 to the liquid developer layer 201Y, thereby localizing the toner particles 1 to the vicinity of the surface of the developing roller 20Y within the liquid developer layer 201Y as shown in FIG. 3. By localizing toner particles in this manner, the developing density (developing efficiency) can be improved, and a sharp image with high quality can be obtained thereby.

A cleaning blade 23Y is provided on the developer compressing roller 22Y.

The cleaning blade 23Y has a function of removing the liquid developer attached to the developer compressing roller 22Y. The liquid developer removed with the cleaning blade 23Y is recovered into the liquid developer storing part 31Y for reuse.

The developing unit 100Y has a developing roller cleaning blade 21Y formed of rubber in contact with the surface of the developing roller 20Y. The developing roller cleaning blade 21Y is a device for scraping and removing the liquid developer remaining on the developing roller 20Y after completing development at the developing position. The liquid developer removed by the developing roller cleaning blade 21Y is recovered into the liquid developer storing part 31Y for reuse.

The image forming apparatus 1000 has, as shown in FIGS. 1 and 2, four liquid developer feeding parts 80Y, 80M, 80C and 80K for feeding the liquid developer to the developing parts 30Y, 30M, 30C and 30K. The liquid developer feeding parts 80Y, 80M, 80C and 80K have the same constitutions, and therefore, the liquid developer feeding part 80Y is described below.

The liquid developer feeding part 80Y has a recovered liquid developer storing part 81Y, a liquid developer replenishing part 82Y, transporting devices 83Y and 84Y, a pump 85Y and a filter 86Y.

The recovered liquid developer storing part 81Y stores mainly the recovered liquid developer recovered by the developer recovering part 18Y, and the recovered liquid developer is fed to the liquid developer storing part 31Y of the developing part 30Y with the transporting device 83Y. The liquid developer replenisher storing part 82Y stores the liquid developer, and the liquid developer is fed to the liquid developer storing part 31Y with the transporting device 84Y. The formulations of the liquid developer stored in the liquid developer replenisher storing part 82Y and the recovered liquid developer stored in the recovered liquid developer storing part 81Y may be the same as or different from that of the liquid developer stored in the liquid developer storing part 31Y.

The liquid developer recovered to the developer recovering part 18Y is fed to the liquid developer feeding part 80Y through a transporting path 70Y.

A pump 85Y is provided on the transporting path 70Y, and the liquid developer recovered to the developer recovering part 18Y is transported to the recovered liquid developer storing part 81Y with the pump 85Y.

A filter 86Y is provided on the transporting path 70Y, with which coarse particles, foreign matters and the like can be removed from the recovered liquid developer. The solid contents including coarse particles, foreign matters and the like thus removed with the filter 86Y are detected with a detecting unit, which is not shown in the figures, for detecting the state of the filter. The filter 86Y is replaced based on the detection result thereof. According to the constitution, the filtering function of the filter 86Y can be stably maintained.

The fixing part will be described.

The fixing part F40 fixes an unfixed toner image F5a formed in the developing part, the transferring part and the like to a recording medium F5.

As shown in FIG. 4, the fixing device F40 has a heat fixing roller F1, a pressure roller F2, a heat resistant belt F3, a belt stretching member F4, a cleaning member F6, a frame F7 and a spring F9.

The heat fixing roller (fixing roller) F1 has a roller substrate Fib constituted by a tubular member, an elastic member F1c covering the outer periphery of the roller substrate F1b, and columnar halogen lamps F1a as a heat source inside the roller substrate F1b, and is rotatable in the anticlockwise direction shown by the arrow in the figure.

Two columnar halogen lamps F1a and F1a constituting a heat source are installed inside the heat fixing roller F1, and heating elements of the columnar halogen lamps F1a and F1a are disposed at positions different from each other. The columnar halogen lamps F1a and F1a are selectively turned on, whereby the temperatures are controlled under different conditions including the fixing nip position where the heat resistant belt F3 described later is wound on the heat fixing roller F1 and the position where the belt stretching member F4 described later is in contact with the heat fixing roller F1, and under different conditions including a recording medium having a large width and a recording medium having a small width.

The pressure roller F2 is disposed to face the heat fixing roller F1 and applies pressure to the recording medium F5 having an unfixed toner image F5a, through the heat resistant belt F3 described later.

The pressure roller F2 has a roller substrate F2b constituted by a tubular member, and an elastic member F2c covering the outer periphery of the roller substrate F2b, and is rotatable in the clockwise direction shown by the arrow in the figure.

A PFA layer is provided as a surface layer of the elastic member F1c of the heat fixing roller F1. According to the constitution, the elastic members F1c and F2c undergo elastic deformation in the substantially same manner to form a so-called horizontal nip although the elastic members F1c and F2c are different from each other in thickness, and no difference is formed in conveying speed between the peripheral speed of the heat fixing roller F1 and the speed of the heat resistant belt F3 or the recording medium F5 described later, whereby the image fixing operation can be carried out considerably stably.

The heat resistant belt F3 is an endless loop belt that is movably stretched on the outer peripheries of the pressure roller F2 and the belt stretching member F4 and held under pressure between the heat fixing roller F1 and the pressure roller F2.

The heat resistant belt F3 has a thickness of 0.03 mm or more and is formed of a seamless tube having a two-layer structure containing a front surface (i.e., the side in contact with the recording medium F5) formed of PFA and a back surface (i.e., the side in contact with the pressure roller F2 and the belt stretching member F4) formed of polyimide. The heat resistant belt F3 is not limited thereto and can be formed of other materials, such as a metallic tube, such as a stainless steel tube and a nickel electroformed tube, and a heat resistant resin tube, such as a silicone tube.

The belt stretching member F4 is disposed on the upstream side of the fixing nip part of the heat fixing roller F1 and the pressure roller F2 in the conveying direction of the recording medium F5 oscillatable in the direction shown by the arrow P with the rotation axis F2a of the pressure roller F2 as the center.

The belt stretching member F4 stretches the heat resistant belt F3 in the tangential direction of the heat fixing roller F1 under the state where the recording medium F5 does not pass through the fixing nip part. There are some cases where the recording medium F5 is not smoothly inserted to the fixing nip part and is wrinkled at the edge thereof upon fixing, in the case where the fixing pressure is too large at the initial position, at which the recording medium F5 is inserted to the fixing nip part. By stretching the heat resistant belt F3 in the tangential direction of the heat fixing roller F1, however, an introducing port, to which the recording medium F5 can be smoothly inserted, can be formed, whereby the recording medium F5 can be stably inserted to the fixing nip part.

The belt stretching member F4 is a belt sliding member having a substantially semilunar shape that is interfit inside the heat resistant belt F3 and applies a tension f to the heat resistant belt F3 associated with the pressure roller F2 (the heat resistant belt F3 slides on the belt stretching member F4). The belt stretching member F4 is disposed at such a position that the nip part is formed by winding the heat resistant belt F3 thereon on the side of the heat fixing roller F1 with respect to the tangential direction L of the contact part under pressure of the heat fixing roller F1 and the pressure roller F2. A projected wall F4a is provided as being protruded from one end or both ends in the axial direction of the belt stretching member F4, and in the case where the heat resistant belt F3 is deviated toward one side in the axial direction, the deviation of the heat resistant belt F3 is regulated by making the heat resistant belt F3 in contact with the projected wall F4a. A spring F9 is provided in a compressed state between the side of the projected wall F4a opposite to the heat fixing roller F1 and the frame F7 to press lightly the projected wall F4a of the belt stretching member F4 onto the heat fixing roller F1, whereby the belt stretching member F4 is in contact under sliding with the heat fixing roller F1 for positioning.

The position where the belt stretching member F4 is lightly pressed onto the heat fixing roller F1 forms the nip start position, and the position where the pressure roller F2 is pressed onto the heat fixing roller F1 forms the nip end position.

In the fixing part F40, the recording medium F5 having an unfixed toner image F5a formed thereon is inserted to the fixing nip part from the nip start position, and then it passes between the heat resistant belt F3 and the heat fixing roller F1 and exits from the nip end position, whereby the unfixed toner image F5a formed on the recording medium F5 is fixed. Subsequently, the recording medium F5 is discharged in the tangential direction L of the contact part under pressure of the heat fixing roller F1 and the pressure roller F2.

The cleaning member F6 is disposed between the pressure roller F2 and the belt stretching member F4.

The cleaning member F6 is in contact under sliding with the inner surface of the heat resistant belt F3 to clean foreign matters and abrasion powder on the inner surface of the heat resistant belt F3. The heat resistant belt F3 is refreshed by cleaning foreign matters and abrasion powder to reduce the destabilizing factor on friction coefficient described before. A concave portion F4f is provided on the belt stretching member F4 for housing the foreign matters and abrasion powder removed from the heat resistant belt F3.

The fixing part F40 has a removing blade (removing unit) F12 that removes the insulating liquid attached to (remaining on) the surface of the heat fixing roller F1 after fixing the toner image F5a to the recording medium F5. The removing blade F12 removes the insulating liquid and simultaneously can remove the toner and the like transferred to the heat fixing roller F1 upon fixing.

For stably driving the heat resistant belt F3, which is stretched on the pressure roller F2 and the belt stretching member F4, with the pressure roller F2, the friction coefficient between the pressure roller F2 and the heat resistant belt F3 may be set larger than the friction coefficient between the belt stretching member F4 and the heat resistant belt F3. However, there are cases where the friction coefficient is destabilized due to insertion of foreign matters between the heat resistant belt F3 and the pressure roller F2 or the heat resistant belt F3 and the belt stretching member F4, or abrasion at the contact part of the heat resistant belt F3 with the pressure roller F2 or the belt stretching member F4.

Therefore, the winding angle of the heat resistant belt F3 on the belt stretching member F4 is set smaller than the winding angle of the heat resistant belt F3 on the pressure roller F2, and the diameter of the belt stretching member P4 is set smaller than the diameter of the pressure roller F2. According to the constitution, the length where the heat resistant belt F3 is in contact under sliding on the belt stretching member F4 is short to avoid the destabilizing factors due to time-lapse deterioration and external disturbance, whereby the heat resistant belt F3 can be stably driven with the pressure roller F2.

The heat applied by the heat fixing roller F1 (fixing temperature) is preferably from 80 to 160° C., more preferably from 100 to 150° C., and further preferably from 100 to 140° C. Since the liquid developer of the embodiment of the invention is excellent in fixing property at a low temperature, a toner image can be firmly fixed to a recording medium even at the relatively low fixing temperature. Furthermore, since the fixing operation can be carried out at the relatively low fixing temperature, the insulating liquid in the liquid developer is particularly less evaporated. Accordingly, the image forming apparatus is particularly harmless to humans and organisms, thereby becomes an environmentally benign apparatus.

The invention has been described with reference to the preferred embodiments, but the invention is not construed as being limited thereto.

For example, the liquid developer according to an embodiment of the invention is not limited to one applied to the image forming apparatus described above.

The liquid developer according to an embodiment of the invention is not limited to those obtained in the production methods described above. For example, the resin solution in the embodiment is prepared by using the pulverized product, which is produced by kneading and pulverizing the colorant and the resin material, but the resin solution may not be produced with a pulverized product and may be obtained, for example, by directly mixing the first liquid, the colorant and the resin material.

### EXAMPLES

### (1) Production of Liquid Developer

### Example 1

### Preparation of Colorant Master (Kneading Step and Pulverizing Step)

A mixture of 40 parts by weight of an ethylene-(meth)acrylic acid copolymer (melting point: 98° C., Vicat softening point: 78° C., Nucrel N410, a trade name, produced by Du Pont-Mitsui Polychemicals Co., Ltd.) as a resin material, 50 parts by weight of a cyan pigment (Pigment Blue 15:3, produced by Dainichiseika Color & Chemicals Mfg. Co., Ltd.) as a colorant, and 10 parts by weight of a dispersant (Adisper PB821, a trade name, produced by Ajinomoto Co., Inc.) was prepared. The components were mixed with a 20-L Henschel mixer to provide a raw material for a colorant master.

The raw material was kneaded with a biaxial kneading extruder heated to 120° C. to provide a kneaded product. The kneaded product extruded from the extrusion port of the biaxial kneading extruder was cooled (kneading step).

The kneaded product thus cooled was coarsely pulverized to form powder having an average particle diameter of 2.0 mm or less, thus a colorant master (pulverized product) was obtained. A hammer mill was used for pulverization of the kneaded product (pulverizing step).

### Resin Solution Preparing Step

50 parts by weight of the resulting colorant master (pulverized product), 50 parts by weight of an ethylene-(meth)acrylic acid copolymer (melting point: 98° C., Vicat softening point: 78° C., Nucrel N410, a trade name, produced by Du Pont-Mitsui Polychemicals Co., Ltd.) as an additional resin material, and 100 parts by weight of methyl laurate (fatty acid monoester, aniline point: −6° C., carbon number of fatty acid: 12, Paster M-12, a trade name, produced by Lion Corp.) as the first liquid were mixed and agitated in a stainless steel vessel with a homogenizer (produced by Microtec Nition Co., Ltd.) at a rotation number of 8,000 rpm under heating to a temperature of the material of 120° C.

When the temperature of the material reached 120° C., the mixture was continuously agitated with the homogenizer at a rotation number of 8,000 rpm while maintaining the temperature constant, so as to provide a resin solution. The pigment was finely dispersed uniformly in the resin solution.

### Resin Depositing Step

The heating operation of the resulting resin solution was terminated, and resin fine particles (toner particles) were deposited under agitating under the same conditions to provide a resin fine particle dispersion liquid having the colored resin fine particles (toner particles) dispersed therein. 300 parts by weight of higholeic rapeseed oil (aniline point: 15° C., Canola Oil, a trade name, produced by The Nisshin OilliO Group, Ltd.) was used as the second liquid. The depositing operation of the resin fine particles was carried out in such a manner that higholeic rapeseed oil at ordinary temperature was added dropwise to the resin solution under agitating, and the resin solution was gradually cooled to room temperature.

5 parts by weight of zirconium octoate (Octope Zr, produced by Hope Chemical Co., Ltd.) as a charge controlling agent and 2 parts by weight of a polyamine fatty acid polymer (Solspdrse 11200, produced by Lubrizol Corp. Japan) as a dispersant were added to the resulting resin fine particle dispersion liquid under agitating to provide a cyan liquid developer. The average particle diameter by volume of the resin fine particles was measured with Mastersizer 2000 (produced by Malvern Instruments, Ltd.). The average particle diameter was 2.3 μm, and the amount of coarse particles having a diameter exceeding 5 μm was less than 1% by volume. A part of the liquid developer was collected, from which a cake (toner particles) was separated by centrifugation. The liquid component contained in the solid content was extracted and then quantitatively analyzed by a gas chromatography method. As a result, the liquid component contained in the toner particles contained mainly methyl laurate. The liquid component was reproduced by mixing the liquids corresponding to the amount ratios of the liquid component thus obtained by the analysis, and measured for aniline point. The aniline point of the liquid component was −5° C. The aniline point of the insulating liquid constituting the liquid developer was 10° C. Accordingly, it was considered that the liquid component entrained into the toner particles was constituted mainly by the first liquid.

### Examples 2 to 11

Liquid developers were produced in the same manner as in Example 1 except that the kinds and the contents of the first liquid and the second liquid were changed as shown in Table 1.

### Comparative Example 1

A mixture of 40 parts by weight of a polyester resin (melting point: 125° C., glass transition temperature: 60° C.) as a resin material, 50 parts by weight of a cyan pigment (Pigment Blue 15:3, produced by Dainichiseika Color & Chemicals Mfg. Co., Ltd.) as a colorant, and 10 parts by weight of a dispersant (Adisper PB821, a trade name, produced by Ajinomoto Co., Inc.) was prepared. The components were mixed with a 20-L Henschel mixer to provide a raw material for a colorant master.

The raw material was kneaded with a biaxial kneading extruder heated to 120° C. to provide a kneaded product. The kneaded product extruded from the extrusion port of the biaxial kneading extruder was cooled.

The kneaded product thus cooled was coarsely pulverized to form powder having an average particle diameter of 2.0 mm or less, thus a colorant master (pulverized product) was obtained. A hammer mill was used for pulverization of the kneaded product.

50 parts by weight of the pulverized product thus obtained and 50 parts by weight of a polyester resin (melting point: 125° C., glass transition temperature: 60° C.) were kneaded with a biaxial kneading extruder heated to 120° C., and then cooled and coarsely pulverized to provide a colored raw material in a powder form having an average particle diameter of 1.0 mm or less.

20 parts by weight of the colored raw material, 80 parts by weight of an aliphatic hydrocarbon (aniline point: 103° C., Cosmo SP-10, produced by Cosmo Oil Lubricants Co., Ltd.) as an insulating liquid, 1 part by weight of zirconium octoate (Octope Zr, produced by Hope Chemical Co., Ltd.) as a charge controlling agent, and 2 parts by weight of a polyamine fatty acid polymer (Solsperse 11200, produced by Lubrizol Corp. Japan) as a dispersant were placed in a planetary ball mill (Planet H, produced by Gokin Planetaring, Inc.), to which zirconia balls having a diameter 1 mm were further added, and the components were pulverized and dispersed for 24 hours. Thus, a liquid developer was obtained.

### Comparative Example 2

A liquid developer was produced in the same manner as in Example 1 except that higholeic rapeseed oil was used as the first liquid and the second liquid.

### Comparative Example 3

A mixture of 40 parts by weight of an ethylene-(meth)acrylic acid copolymer (melting point: 98° C., Vicat softening point: 78° C., Nucrel N410, a trade name, produced by Du Pont-Mitsui Polychemicals Co., Ltd.) as a resin material, 50 parts by weight of a cyan pigment (Pigment Blue 15:3, produced by Dainichiseika Color & Chemicals Mfg. Co., Ltd.) as a colorant, 10 parts by weight of a dispersant (Adisper PB821, a trade name, produced by Ajinomoto Co., Inc.), and 10 parts by weight of an aliphatic hydrocarbon (aniline point: 103° C., Cosmo SP-10, produced by Cosmo Oil Lubricants Co., Ltd.) as a liquid component was prepared. The components were mixed with a 20-L Henschel mixer to provide a raw material for a colorant master.

The raw material was kneaded with a biaxial kneading extruder heated to 120° C. to provide a kneaded product. The kneaded product extruded from the extrusion port of the biaxial kneading extruder was cooled.

The kneaded product thus cooled was coarsely pulverized to form powder having an average particle diameter of 2.0 mm or less, thus a colorant master (pulverized product) was obtained. A hammer mill was used for pulverization of the kneaded product.

55 parts by weight of the pulverized product thus obtained and 50 parts by weight of an ethylene-(meth) acrylic acid copolymer (melting point: 98° C., Vicat softening point: 78° C., Nucrel N410, a trade name, produced by Du Pont-Mitsui Polychemicals Co., Ltd.) were kneaded with a biaxial kneading extruder heated to 120° C., and then cooled and coarsely pulverized to provide a colored raw material in a powder form having an average particle diameter of 1.0 mm or less.

21 parts by weight of the colored raw material, 75 parts by weight of an aliphatic hydrocarbon (aniline point: 103° C., Cosmo SP-10, produced by Cosmo Oil Lubricants Co., Ltd.) as an insulating liquid, 1 part by weight of zirconium octoate (Octope Zr, produced by Hope Chemical Co., Ltd.) as a charge controlling agent, and 2 parts by weight of a polyamine fatty acid polymer (Solsperse 11200, produced by Lubrizol Corp. Japan) as a dispersant were placed in a planetary ball mill (Planet H, produced by Gokin Planetaring, Inc.), to which zirconia balls having a diameter 1 mm were further added, and the components were pulverized and dispersed for 24 hours. Thus, a liquid developer was obtained.

### Comparative Example 4

A liquid developer was produced in the same manner as in Comparative Example 3 except that methyl laurate was used as the liquid component and the insulating liquid instead of the aliphatic hydrocarbon (Cosmo SP-10).

### Comparative Example 5

A liquid developer was produced in the same manner as in Comparative Example 3 except that methyl laurate was used as the insulating liquid instead of the aliphatic hydrocarbon (Cosmo SP-10).

The resin materials, the first liquids and the second liquids used for producing the liquid developers of Examples and Comparative Examples are shown in Table 1 below.

In Table 1, as the resin material, the polyester resin is represented by PEs, and the ethylene-(meth)acrylic acid copolymer is represented by EMAA. In the Table, the higholeic rapeseed oil is represented by HO rapeseed oil. In Examples and Comparative Examples, Prifer 6813 (aniline point: −10° C., produced by UNIQEMA) and DBE (aniline point: −15° C., produced by Invista Japan, Inc.) as a synthetic ester liquid, 40-S (aniline point: 86° C., produced by Sanko Chemical Industry Co., Ltd.) as an aliphatic hydrocarbon, KF9G (aniline point: 126° C., viscosity: 100 mPa·s, produced by Shin-Etsu Silicone Co., Ltd.) as a silicone oil, soybean oil (aniline point: 12° C., produced by Nisshin OilliO Group, Ltd.) as a fat, and the like were used as the first liquid and the second liquid, in addition to the aforementioned liquids. In Examples and Comparative Examples, the fatty acid monoester other than those described above which is used as first liquid, were obtained through ester exchange of fatty acids and alcohol components. In Table 1, the aniline points were values measured according to JIS K2256. The aniline point of the first liquid is represented by AP (A) (° C.), and the aniline point of the second liquid is represented by AP (B) (° C.). In Table 1, the melting point of the resin material measured according to JIS K7121 1987 is represented by Tm (° C.). In the column of “Vicat softening point or glass transition temperature” in the table, the Vicat softening point Tv (° C.) measured according to JIS K7026 1999 is shown for the ethylene-(meth)acrylic acid copolymer, and the glass transition temperature Tg (° C.) measured according to JIS K7121 is shown for the polyester resin.

TABLE 1

| | Resin material | | | | | | | | | | | |
|---|---|---|---|---|---|---|---|---|---|---|---|---|
| | | Vicat softening | | | | | | | | | | |
| | | point Tv (° C.) | | | | | | | Second liquid | | | |
| | | or glass | Melting | | | First liquid | | | | Aniline | | |
| | | transition | point | Tm − Tv | Content | | Aniline | Content | | point | Content | AP |
| | | temperature | Tm | or | (% by | | point AP | (% by | | AP (A) | (% by | (B) − AP |
| | Kind | Tg (° C.) | (° C.) | Tm − Tg | weight) | Kind | (A) (° C.) | weight) | Kind | (° C.) | weight) | (A) |
| Example 1 | EMAA | 78 | 98 | 20 | 13.8 | methyl | −6 | 19.7 | HO | 15 | 59.2 | 21 |
| | | | | | | laurate | | | rapeseed | | | |
| | | | | | | | | | oil | | | |
| Example 2 | EMAA | 78 | 98 | 20 | 13.8 | methyl | −2 | 19.7 | HO | 15 | 59.2 | 17 |
| | | | | | | soybean oil | | | rapeseed | | | |
| | | | | | | fatty acid | | | oil | | | |
| | | | | | | ester | | | | | | |
| Example 3 | EMAA | 63 | 93 | 30 | 13.8 | methyl | −2 | 19.7 | HO | 15 | 59.2 | 17 |
| | | | | | | laurate | | | rapeseed | | | |
| | | | | | | | | | oil | | | |
| Example 4 | EMAA | 78 | 98 | 20 | 13.8 | methyl | −2 | 19.7 | Cosmo | 103 | 59.2 | 105 |
| | | | | | | laurate | | | SP-10 | | | |
| Example 5 | EMAA | 78 | 98 | 20 | 13.8 | methyl | −2 | 19.7 | KF-96 | 126 | 59.2 | 128 |
| | | | | | | laurate | | | | | | |
| Example 6 | PEs | 63 | 135 | 72 | 13.8 | Prifer 6813 | −10 | 19.7 | 40-S | 86 | 59.2 | 96 |
| Example 7 | EMAA | 78 | 98 | 20 | 13.8 | Prifer 6813 | −10 | 19.7 | HO | 15 | 59.2 | 25 |
| | | | | | | | | | rapeseed | | | |
| | | | | | | | | | oil | | | |
| Example 8 | EMAA | 78 | 98 | 20 | 13.8 | isobutyl | −1 | 23.7 | HO | 15 | 55.2 | 16 |
| | | | | | | laurate | | | rapeseed | | | |
| | | | | | | | | | oil | | | |
| Example 9 | EMAA | 78 | 98 | 20 | 13.8 | pentyl | 2 | 25.7 | soybean | 12 | 53.2 | 10 |
| | | | | | | laurate | | | oil | | | |
| Example 10 | EMAA | 78 | 98 | 20 | 13.8 | methyl | −4 | 25.7 | soybean | 12 | 53.2 | 16 |
| | | | | | | myristate | | | oil | | | |
| Example 11 | PEs | 54 | 116 | 62 | 13.8 | DBE | −15 | 19.7 | 40-S | 86 | 59.2 | 101 |
| Comparative | PEs | 60 | 125 | 65 | 13.8 | — | — | — | — | — | — | — |
| Example 1 | | | | | | | | | | | | |
| Comparative | EMAA | 78 | 98 | 20 | 13.8 | HO rapeseed | 15 | 19.7 | HO | 15 | 59.2 | 0 |
| Example 2 | | | | | | oil | | | rapeseed | | | |
| | | | | | | | | | oil | | | |
| Comparative | EMAA | 78 | 98 | 20 | 13.8 | — | — | — | — | — | — | — |
| Example 3 | | | | | | | | | | | | |
| Comparative | EMAA | 78 | 98 | 20 | 13.8 | — | — | — | — | — | — | — |
| Example 4 | | | | | | | | | | | | |
| Comparative | EMAA | 78 | 98 | 20 | 13.8 | — | — | — | — | — | — | — |
| Example 5 | | | | | | | | | | | | |

### (2) Evaluation

The liquid developers thus obtained were evaluated in the following manner.

### (2-1) Fixing Strength

Monochrome images having a prescribed pattern were formed on recording paper (high quality paper, LPCPPA4, produced by Seiko Epson Corp.) with the liquid developers obtained in Examples and Comparative Examples using an image forming apparatus shown in FIGS. 1 to 4. The images were then heat fixed with the temperature of the heat fixing roller set to 115° C. at a fixing rate of 50 sheets per minute.

Thereafter, the non-offset area was confirmed, and then the fixed image on the recording paper was rubbed with a rubber eraser (sand eraser, LION 261-11, produced by Lion Office Products Corp.) twice with a pressing load of 1.1 kgf. The remaining rate of the image density was measured with X-Rite Model 404, produced by X-Rite, Inc., and evaluated based on the following five grades.

Excellent (A): image density remaining rate of 95% or more
Good (B): image density remaining rate of 90% or more and less than 95%
Allowable (C): image density remaining rate of 80% or more and less than 90%
Slightly poor (D): image density remaining rate of 70% or more and less than 80%
Poor (E): image density remaining rate of less than 70%

It was confirmed that there was no evaporation of the insulating liquid upon fixing with the liquid developers of Examples (generation of smell or steam).

### (2-2) Low Temperature Fixing Property

The toners obtained in Examples and Comparative Examples were evaluated for favorably fixable range and low temperature fixing property.

An image forming apparatus having the same constitution as shown in FIGS. 1 to 3 except that the apparatus had no fixing device was prepared. Image samples having an unfixed monochrome toner image formed on a recording medium (high quality paper, LPCPPA4, produced by Seiko Epson Corp.) were prepared by using the image forming apparatus. The solid image on the samples had an attached amount of the toner set to 0.4 mg/cm².

The surface temperature of the fixing roller of the fixing device constituting the image forming apparatus was set to a prescribed temperature, and the recording medium having the unfixed toner image formed thereon was inserted into the fixing device shown in FIG. 4, whereby the toner image was fixed to the recording medium. The occurrence of offset after fixing was then confirmed visually. In the fixing device, the fixing rate was 50 sheets per minute (number of sheets of A4 size paper passing through the nip part). The temperature of the surface of the fixing roller was changed sequentially within a range of from 60 to 160° C., and the occurrence of offset at the temperatures was confirmed. The maximum temperature where low temperature offset occurred was designated as a low temperature offset occurring temperature, which was evaluated based on the following four grades.

Excellent (A): low temperature offset occurring temperature of less than 95° C.
Good (B): low temperature offset occurring temperature of 95° C. or more and less than 110° C.
Slightly poor (C) low temperature offset occurring temperature of 110° C. or more and less than 120° C.
Poor (D): low temperature offset occurring temperature of 120° C. or more

### (2-3) Long-Term Stability of Toner Image (Stable Period)

Monochrome images having a prescribed pattern were formed on recording paper (high quality paper, LPCPPA4, produced by Seiko Epson Corp.) with the liquid developers obtained in Examples and Comparative Examples using an image forming apparatus shown in FIGS. 1 to 4. The images were then heat fixed with the temperature of the heat fixing roller set to 140° C. Immediately after fixing, the image density of the toner images was measured with X-Rite Model 404, produced by X-Rite, Inc. Thereafter, the images were allowed to stand under an atmosphere of a temperature of from 10 to 40° C. and a humidity of from 50 to 70% under sunlight. The non-offset area of the toner images was confirmed in every one month, and then the fixed image on the recording paper was rubbed with a rubber eraser (sand eraser, LION 261-11, produced by Lion Office Products Corp.) twice with a pressing load of 1.0 kgf. The image density was then measured with X-Rite Model 404, produced by X-Rite, Inc. The period where the remaining rate of the density of the toner image is 60% or more based on the image density immediately after formation and fixing was designated as the stable period of the toner image, which was evaluated based on the following five grades.

Excellent (A): stable period of toner image of 24 months or more
Good (B): stable period of toner image of 18 months or more and less than 24 months
Allowable (C): stable period of toner image of 12 months or more and less than 18 months
Slightly poor (D): stable period of toner image of 6 months or more and less than 12 months
Poor (E): stable period of toner image of less than 6 months

### (2-4) Storage Stability

The liquid developers obtained in Examples and Comparative Examples were allowed to stand under an environment at a temperature of from 15 to 25° C. for 6 months. Thereafter, the state of the toner contained in the liquid developer was visually observed and evaluated based on the following five grades.

A: Completely no floatage or precipitation due to aggregation of toner particles found
B: Substantially no floatage or precipitation due to aggregation of toner particles found
C: Slight floatage and precipitation due to aggregation of toner particles found without problem upon using as liquid developer
D: Floatage and precipitation due to aggregation of toner particles clearly found
E: Floatage and precipitation due to aggregation of toner particles considerably found

### (2-5) Environmental Stability (Long-Term Stability) of Liquid Developer

The liquid developers obtained in Examples and Comparative Examples were allowed to stand under an environment at a temperature of 40° C. and a relative humidity of 65% for 5 months. Thereafter, the state of the liquid developer was observed, and changes in viscosity, color, acid value and electric resistance before and after allowing to stand were evaluated based on the following five grades. The acid value was measured according to JIS K2501. The change in color of the liquid developer was evaluated visually. The viscosity was measured with a vibration viscometer according to CIS Z8809. The electric resistance was measured with Universal Electrometer MMA II-17B with an electrode for liquid LP-05 and a shield box P-618 (produced by Kawaguchi Electric Works, Co., Ltd.).

A: Completely no change in viscosity, color, acid value and electric resistance found
B: Substantially no change in viscosity, color, acid value and electric resistance found
C: Slight change in viscosity, color, acid value and electric resistance found without problem upon using as liquid developer
D: Change in viscosity, color, acid value and electric resistance clearly found
E: Change in viscosity, color, acid value and electric resistance considerably found

The results obtained are shown in Table 2 along with the constitutions of the liquid developers. The melting point of the toner particles was measured in such a manner that the toner particles were filtered from the resulting liquid developer by centrifugation and measured for melting point according to JIS K7121 1987. The aniline point of the liquid component in the toner particles is represented by AP (a) (° C.), and the aniline point of the insulating liquid is represented by AP(b) (° C.).

The aniline point of the liquid component contained in the toner particles was measured in the following manner. A part of the liquid developer was collected, from which a cake (toner particles) was separated by centrifugation. The liquid component contained in the solid content was extracted and then quantitatively analyzed by a gas chromatography method. The liquid component was then reproduced by mixing the liquids corresponding to the amount ratios of the liquid component thus obtained by the analysis, and measured for aniline point.

In the columns of “Fixing strength”, “Low temperature fixing property” and “Stable period of toner image”, specific values of the remaining rate of image density (%), the low temperature offset occurring temperature (° C.) and the stable period of toner image (month) are shown in parentheses.

TABLE 2

| | Toner particles | | | | | | | | | | |
|---|---|---|---|---|---|---|---|---|---|---|---|
| | | Particles | | Aniline | Aniline | | | Low | | | |
| | Average | exceeding | | point of | point of | | | temperature | Stable | | |
| | particle | 5 μm | Melting | liquid | insulating | | | offset | period | | |
| | diameter | (% by | point | component | liquid AP (b) | AP (b) − AP | Fixing | occurring | of toner | Storage | Environmental |
| | (μm) | volume | (° C.) | AP (a) (° C.) | (° C.) | (a) | strength | temperature | image | stability | stability |
| Example 1 | 2.3 | 0.2 | 79 | −5 | 10 | 15 | A (98) | B (95) | A (32) | A | A |
| Example 2 | 2.6 | 0.4 | 87 | 0 | 12 | 12 | A (97) | B (105) | A (36) | A | B |
| Example 3 | 1.9 | 0.3 | 78 | −1 | 10 | 11 | A (96) | A (90) | A (28) | A | A |
| Example 4 | 1.7 | 2.3 | 75 | 3 | 75 | 72 | A (95) | B (100) | C (12) | B | A |
| Example 5 | 1.7 | 2.5 | 82 | 4 | 95 | 91 | A (96) | B (105) | C (14) | B | A |
| Example 6 | 2.4 | 1.5 | 120 | 2 | 60 | 58 | A (95) | B (100) | B (18) | B | A |
| Example 7 | 2.3 | 0.3 | 83 | −8 | 9 | 17 | A (96) | B (95) | A (29) | A | A |
| Example 8 | 2.3 | 0.6 | 60 | 0 | 11 | 11 | B (92) | B (105) | A (28) | A | A |
| Example 9 | 2.3 | 0.9 | 88 | 3 | 9 | 6 | C (88) | C (110) | A (27) | C | B |
| Example 10 | 2.4 | 0.8 | 85 | 0 | 10 | 10 | B (92) | B (105) | A (28) | B | B |
| Example 11 | 2.1 | 0.9 | 101 | −10 | 56 | 66 | A (96) | B (95) | B (19) | B | A |
| Comparative | 2.8 | 15 | 125 | — | 103 | — | E (83) | D (135) | E (5) | C | A |
| Example 1 | | | | | | | | | | | |
| Comparative | 2.9 | 0.4 | 96 | 15 | 15 | 0 | E (66) | D (125) | A (35) | A | B |
| Example 2 | | | | | | | | | | | |
| Comparative | 2.6 | 13.2 | 98 | 103 | 103 | 0 | E (63) | D (140) | E (1) | A | A |
| Example 3 | | | | | | | | | | | |
| Comparative | 2.1 | 8.3 | 78 | −6 | −6 | 0 | A (96) | A (90) | A (28) | E | D |
| Example 4 | | | | | | | | | | | |
| Comparative | 2.3 | 4.5 | 98 | 103 | −6 | −109 | E (61) | D (130) | E (1) | E | C |
| Example 5 | | | | | | | | | | | |

It was found from Table 2 that the liquid developer of the embodiment of the invention was suitable for low temperature fixing, and a toner image obtained was firmly fixed to the recording medium even upon fixing at a low temperature. The liquid developer of the embodiment of the invention did not suffer change in dispersibility of the toner particles and deterioration in quality of the liquid developer even after storing a prolonged period of time, and thus was excellent in storage stability and environmental stability. On the other hand, the liquid developers of Comparative Examples failed to provide sufficient results.

As shown in Table 2, the melting points of the toner particles in Examples were lower than the melting points of the resin materials used, respectively. It is considered that this is because the liquid component contained in the toner particles plasticizes the resin material.

In Examples using HO rapeseed oil and soybean oil containing mainly a fatty acid triglyceride, the amount of coarse particles in the liquid developer was particularly small. It is considered that this is because the fatty acid triglyceride has high affinity with the synthetic ester liquid or the fatty acid monoester, thereby providing less concentration unevenness of the fatty acid triglyceride in the resin solution upon adding dropwise the second liquid.

The toner images formed with the liquid developers using the methyl soybean oil fatty acid ester, the higholeic rapeseed oil or the soybean oil as the first liquid and the second liquid exhibited excellent fixing strength for a prolonged period of time. It is considered that this is because an unsaturated fatty acid component is contained in the liquids, whereby the toner image becomes stable upon storing for a prolonged period of time.

The first liquid and the second liquid used in Examples and the liquid developers obtained were measured for initial boiling point of the insulating liquids with an automatic distillation tester (AMD-1E, produced by Meitec Corp.) according to JIS K2254. All the insulating liquids of Examples had an initial boiling point of 108° C. or more.

All the liquid developers of Examples had a viscosity of 1,000 mPa·s or less and were capable of forming an image favorably with the image forming apparatus described above.

Production and evaluation of liquid developers were carried out in the same manner as above except that Pigment Red 122, Pigment Yellow 180 and carbon black (Printex L, produced by Degussa AG) were used as the colorant instead of the cyan pigment, and thus the similar results as above were obtained.

The entire disclosure of Japanese Patent Application No. 2007-146281, filed May 31, 2007 is expressly incorporated by reference herein.

What is claimed is:

1. A liquid developer comprising:
toner particles containing mainly a resin material, and a nonvolatile insulating liquid,
the toner particles containing a liquid having a formulation that is different from the insulating liquid, and
the liquid contained in the toner particles having an aniline point that is lower than that of the insulating liquid.

2. The liquid developer as claimed in claim 1, wherein the liquid contained in the toner particles has an aniline point of 30° C. or less, and the insulating liquid has an aniline point of from 5 to 100° C.

3. The liquid developer as claimed in claim 1, wherein the liquid developer satisfies the relationship, 10≦AP(b)−AP(a)≦100, wherein AP(a) (° C.) represents the aniline point of the liquid contained in the toner particles, and AP(b) (° C.) represents the aniline point of the insulating liquid.

4. The liquid developer as claimed in claim 1, wherein the resin material has a melting point of from 80 to 140° C. measured according to JIS K7121 1987.

5. The liquid developer as claimed in claim 1, wherein the resin material contains an ethylene copolymer and has a Vicat softening temperature of from 40 to 100° C. measured according to JIS K7026 1999.

6. The liquid developer as claimed in claim 5, wherein the liquid developer satisfies the relationship, Tm-Tv≦50, wherein Tv (° C.) represents the Vicat softening point of the resin material measured according to JIS K7026 1999, and Tm (° C.) represents the melting point of the resin material measured according to JIS K7121 1987.

7. The liquid developer as claimed in claim 1, wherein the resin material contains a polyester resin and has a glass transition temperature of from 40 to 75° C. measured according to JIS K7121.

8. The liquid developer as claimed in claim 7, wherein the liquid developer satisfies the relationship, Tm-Tg≦80, wherein Tg (° C.) represents the glass transition temperature of the resin material measured according to JIS K7121, and Tm (° C.) represents the melting point of the resin material measured according to JIS K7121 1987.

9. An image forming apparatus comprising:
plural developing units that provide plural monochrome images having different colors by using plural liquid developer having the different colors;
an intermediate transferring unit that forms an intermediate transferred image containing the plural monochrome images formed in the developing units, the plural monochrome images being sequentially transferred and overlapped to form the intermediate transferred image;
a secondary transferring unit that transfers the intermediate transferred image to a recording medium to form an unfixed color image on the recording medium; and
a fixing unit that fixes the unfixed color image to the recording medium,
liquid developers each containing toner particles containing mainly a resin material, and an insulating liquid,
the toner particles containing a liquid having a formulation that is different from the insulating liquid, and
the liquid contained in the toner particles having an aniline point that is lower than that of the insulating liquid.
